(19) United States
(12) Patent Application Publication
(10) Pub. No.: US 2010/0100604 A1
(43) Pub. Date: Apr. 22, 2010

(54) CACHE CONFIGURATION SYSTEM, MANAGEMENT SERVER AND CACHE CONFIGURATION MANAGEMENT METHOD

(76) Inventors: Noriki Fujiwara, Yokohama (JP); Nobuo Beniyama, Yokohama (JP); Hiroshi Nojima, Fujisawa (JP)

Correspondence Address: MATTINGLY & MALUR, P.C., 1800 DIAGONAL ROAD, SUITE 370, ALEXANDRIA, VA, 22314, US

(21) Appl. No.: 12/351,147

(22) Filed: Jan. 9, 2009

(30) Foreign Application Priority Data
Oct. 20, 2008 (JP) 2008-269366

(51) Int. Cl. G06F 15/167; G06F 12/08

(52) U.S. Cl. 709/213; 711/118; 711/E12.001; 711/E12.041; 711/E12.017

(57) ABSTRACT

A cache configuration management system capable of lightening workloads of estimation of a cache capacity in virtualization apparatus and/or cache assignment is provided. In a storage system having application servers, storage devices, a virtualization apparatus for letting the storage devices be distinctly recognizable as virtualized storages, and a storage management server, the storage management server predicts a response time of the virtualization apparatus with respect to a application server from cache configurations and access performances of the virtualization apparatus and storage device and then evaluates the presence or absence of the assignment to a virtual volume of internal cache and a predictive performance value based on a to-be-assigned capacity to thereby perform judgment of the cache capacity within the virtualization apparatus and estimation of an optimal cache capacity, thus enabling preparation of an internal cache configuration change plan.

### INCORPORATION BY REFERENCE

The present application claims priority from Japanese application JP 2008-269366 filed on Oct. 20, 2008, the content of which is hereby incorporated by reference into this application.

### BACKGROUND OF THE INVENTION

The present invention relates generally to storage device virtualization architectures, and more particularly to a cache configuration management system, management server and cache configuration management method capable of lessening the workload in estimation of a cache capacity within a virtualization apparatus while reducing complexities in cache assignment processes.

Advances in large-scaling of storage area network (SAN) environment result in increases in costs for operation and management of storage devices, which are of various model types and vendors. Consequently, for effective use of storage resources and reduction of system management costs, a virtualization technique is becoming widespread, which maps storage regions of a plurality of storage devices to inside of a virtualization apparatus to thereby consolidate the operation and management.

However, a virtualized storage system is such that data must pass through the virtualization apparatus whenever access is given from a server, resulting in a decrease in performance in some cases. JP-A-2007-179156 discloses therein an access performance enhancement method adaptable for use in a virtualization apparatus-introduced storage system, which method includes the steps of measuring a response time with respect to each external subsystem from a virtualization apparatus and then assigning an increased amount of cache to an external subsystem with a long response time to thereby improve the access performance.

### SUMMARY OF THE INVENTION

The storage system as taught from JP-A-2007-179156 suffers from problems which follow: it does not obtain any predictive value of the response time after completion of cache assignment; and, it fails to take into consideration a response time which is one of target performance values (referred to as “target response time” hereinafter) to be required by an application program for storage.

This invention is the one that solves the above-noted problems, and its object is to provide a cache configuration management system, management server and cache configuration management method capable of lightening workloads of estimation of cache capacity within a virtualization apparatus and cache assignment while giving consideration to a target performance value or values.

To attain the foregoing object, a storage system is provided which has application servers (for example, application servers 101), storage devices (e.g., storages 106), a virtualization apparatus (e.g., virtualization apparatus 105) for enabling discriminative recognition of the storage devices as virtualized storages, and a management server (e.g., storage management server 107), wherein the management server predicts a response time of the virtualization apparatus with respect to any one of the application servers from cache configurations and access performances of the virtualization apparatus and storage device and then evaluates the presence or absence of the assignment to a virtual volume (e.g., virtual volume 125) of internal cache (e.g., internal cache 123) and a predictive performance value based on a to-be-assigned cache capacity to thereby perform judgment of the cache capacity within the virtualization apparatus which satisfies a target performance value and estimation of an optimal cache capacity, thus preparing an internal cache configuration change plan while letting it be modifiable by users if necessary.

According to this invention, it is possible to lighten the workload of the estimation of cache capacity in the virtualization apparatus and the cache assignment while taking account of the target performance value.

Other objects, features and advantages of the invention will become apparent from the following descriptions of the embodiments of the invention taken in conjunction with the accompanying drawings.

### BRIEF DESCRIPTION OF THE DRAWINGS

FIG. 1A is a block diagram of a storage system in accordance with a first embodiment of the present invention.

FIG. 1B is a block diagram of a virtualization apparatus and storage devices which are externally connected to the virtualization apparatus in the first embodiment of this invention.

FIG. 2 is a block diagram of a memory on a storage management server in the first embodiment of this invention.

FIG. 3 is a diagram for explanation of the contents of a cache configuration table.

FIG. 4 is an explanation diagram showing the contents of an access performance table.

FIG. 5A is an explanation diagram showing the contents of a policy definition table.

FIG. 5B is an exemplary display screen showing a policy definition information setup method.

FIG. 6 is an explanation diagram showing basics as to a cache capacity and cache hit rate.

FIG. 7 is an explanation diagram showing the contents of a cache hit rate table.

FIG. 8A is an explanation diagram showing the contents of an internal cache configuration change plan storage table.

FIG. 8B is an exemplary display screen showing a confirming/re-setup method of the internal cache configuration change plan.

FIG. 9 is a flow chart showing a procedure of internal cache configuration change plan preparation processing.

FIG. 10 is a flowchart showing a procedure of internal cache capacity estimation processing.

FIG. 11 is a flowchart showing a procedure of internal cache assignment capable/incapable judgment processing.

FIG. 12 is a flowchart showing a procedure of surplus internal cache adding distribution processing.

FIG. 13 is an explanation diagram showing the contents of an input/output (I/O) characteristics history table which stores therein I/O characteristics measured.

FIG. 14 is an explanation diagram showing the contents of an internal cache configuration change schedule table.

FIG. 15 is a flowchart showing a procedure of I/O characteristics-based internal cache configuration change schedule preparation processing.

FIG. 16 is a block diagram of a storage system in accordance with a second embodiment of this invention.

FIG. 17 is a block diagram of a memory on a storage management server in the second embodiment of the invention.

FIG. 18 is an explanation diagram showing a response time evaluation method.

FIG. 19 is a flowchart showing a procedure of built-in cache capacity estimation processing.

FIG. 20 is a flowchart showing a procedure of internal cache assignment judgment processing.

FIG. 21 is an exemplary display screen showing a result of the built-in cache capacity estimation processing.

### DETAILED DESCRIPTION OF THE EMBODIMENTS

### First Embodiment

Currently preferred embodiments of this invention will be described in detail with reference to the accompanying drawings below. In a first embodiment, in cases where a logical volume within a storage device that is externally connected to a virtualization apparatus is taken into the virtualization apparatus side for use as a virtual volume, the capacity of a cache within the virtualization apparatus to be assigned to the virtual volume by an operations management software program is changed to a suitable capacity which ensures a target response time to be satisfied. A method for doing this will be explained in detail below.

### System Configuration in First Embodiment

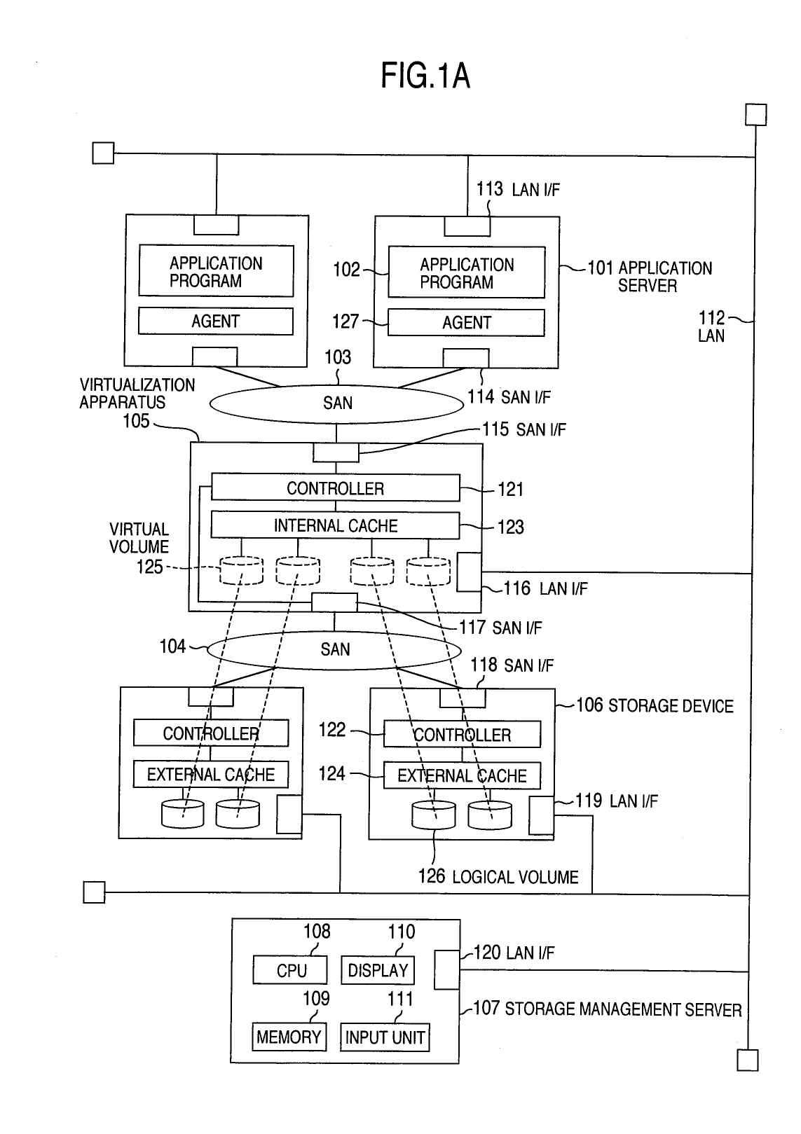

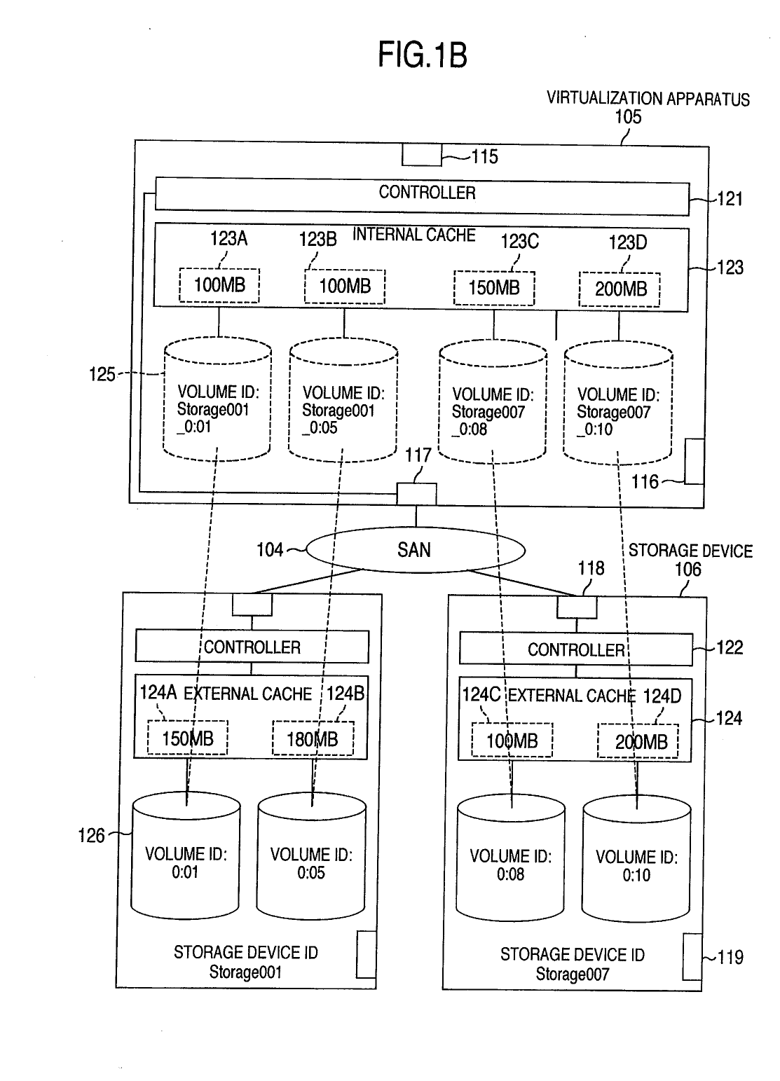

FIG. 1A is a block diagram showing a storage system in the first embodiment of this invention. A plurality of business service/application processing servers 101 and a virtualization apparatus 105 are connected to a storage area network (SAN) 103. The virtualization apparatus 105 and a plurality of storage devices 106 are linked to another SAN 104. SANs 103 and 104 (first network) are separated from each other as shown in FIG. 1A, although these may be combined together into a single network. The application servers 101 may be replaced with a single one. Similarly, the storage devices 106 may be replaced by a one storage device. Each storage device 106 has its own attribute (e.g., vendor), which may be the same as that of the virtualization apparatus 105 or, alternatively, may be different therefrom. The virtualization apparatus 105 may also be arranged to have the form of a switch apparatus making up a communications network.

### (Storage Device)

The storage device 106 has a controller 122, external cache 124, logical volume 126, SAN interface 118 and local area network (LAN) interface 119. The controller 122 is a control unit which performs input/output control of data to be sent to and received from the external cache 124 and logical volume 126. It also measures a cache hit rate of the external cache 124 (referred to as “external cache hit rate” hereinafter). Information measured is transmitted to a storage management server 107 (management server) by way of a LAN 112 (second network).

Virtualization apparatus

The virtualization apparatus 105 has a SAN interface 115 and SAN interface 117. The virtualization apparatus 105 is connected by the SAN interface 115 to SAN 103 and also linked to the SAN 104 via SAN interface 117. Virtualization apparatus 105 also has a LAN interface 116 and is linked to the LAN 112 by this LAN interface 116.

The virtualization apparatus 105 performs virtualization in a predetermined way and is thus able to provide any one of the application servers 101 with a volume of storage device 106 as its own volume. The virtualization apparatus 105 may have therein a logical volume or, alternatively, may have no such volume.

A virtual volume 125 which is indicated by dotted line within the virtualization apparatus 105 is the one that shows a state in which the logical volume 126 within storage device 106 is taken into the virtualization apparatus 105 side. More specifically, in this embodiment, it is possible to provide the application server 101 with storage resources of the logical volume 126 while letting the logical volume 126 that externally exists when looking at from the virtualization apparatus 105 be the virtual volume 125 within the virtualization apparatus 105.

A controller 121 is a control unit which performs input/output control of data with respect to the internal cache 123 and virtual volume 125. In addition, it measures a cache hit rate of the internal cache 123 (referred to as “internal cache hit rate” hereinafter). The information measured is sent to the storage management server 107 via LAN 112.

FIG. 1B is an explanation diagram showing details of the virtualization apparatus 105 and storage devices 106. In FIG. 1B, the virtualization apparatus 105 and SAN 104 plus storage devices 106 are extracted from FIG. 1A for showing the internal cache 123 and external cache 124 therein. In a case where two or more logical volumes 126 are present in each storage device 106, volume identification (ID) codes which are unique numbers within one storage device 106 are allocated in order to distinguish between respective logical volumes 126. In case a plurality of storage devices 106 exist, storage device IDs which are unique numbers within an entirety of the storage system are allocated by a cache configuration information collecting program 1001—this will be later described in detail-in order to distinguish each storage device 106 from the others. In this embodiment, the volume ID of virtual volume 125 is arranged so that the storage device 106's storage device ID and volume ID are coupled together by an underbar.

The internal cache 123 and external cache 124 are such that a certain amount of capacity is assignable per virtual volume 125 and per logical volume 126, respectively. In this embodiment the cache assigning unit is set to a volume, although the assignment may alternatively be performed per storage device 106. Further, the cache assignment may also be done per group of redundant array of independent disks (RAID), wherein the RAID group is also called the “parity group” or “array group” in some cases.

The reference numerals 123A to 123D within the internal cache 123 and numerals 124A to 124D in the storage device 106 are each used to indicate a cache capacity which is assigned to a volume. For example, a cache capacity which is assigned to a virtual volume 125 with its volume ID being set to “Storage001_{—}0:01” is 100 megabytes (MB) as indicated by the numeral 123A. A capacity of the external cache 124 which is assigned to a logical volume 126 with its volume ID being “0:08” within the storage device 106 with its storage device ID of “Storage007” is 100 MB as indicated by the numeral 124C.

### (Application Server)

Turning back to FIG. 1A, the individual application server 101 has a SAN interface 114 and is linked to the SAN 103 by this SAN interface 114. The application server 101 also has a LAN interface 113 and is linked to the LAN 112 via LAN interface 113. The application server 101 includes an application program 102 and agent 127 which are operative thereon. One or a plurality of application programs 102 is/are installable in one application server 101. The agent 127 functions to collect access information relative to each volume, to and from which data is written or read by the application program(s) 102. The agent 127 also gather information as to a response time, which is a time period between an instant at which the application program 102 issues a command of data write or read toward the virtualization apparatus 105 and an instant whereat a reply is returned therefrom. The information collected will be sent forth to the storage management server 107 via LAN 112.

### (Storage Management Server)

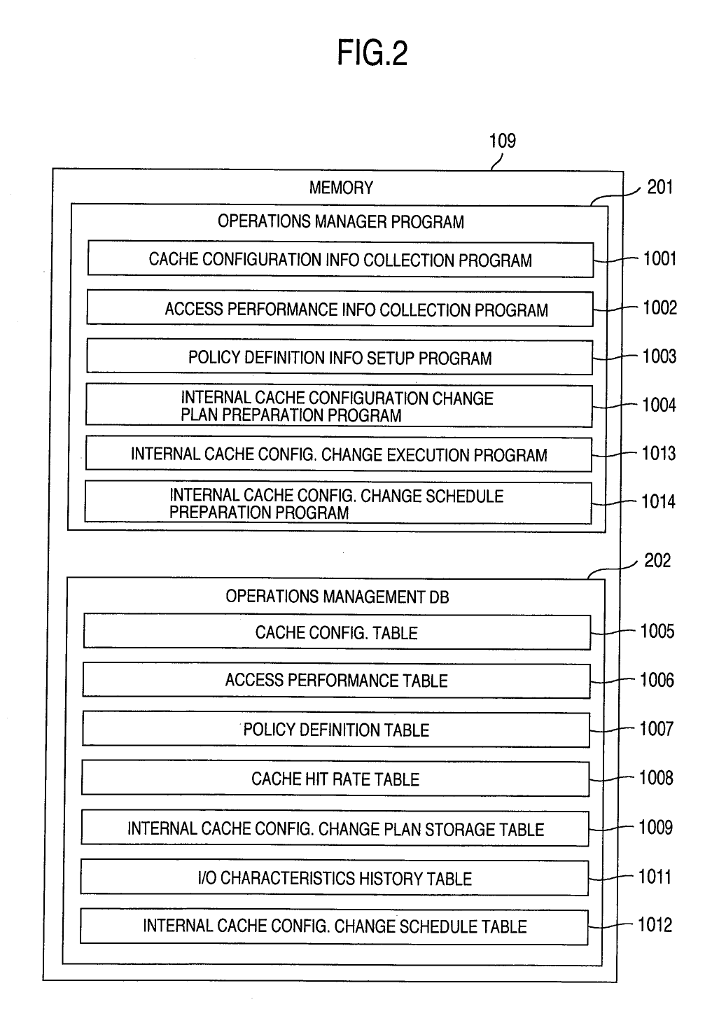

The storage management server 107 is equipped with a central processing unit (CPU) 108, memory 109, display unit 110, input unit 111 and LAN interface 120, and is linked to the LAN 112 by LAN interface 120. The storage management server 107 receives via LAN 112 those information items that are gathered by the agent 127 and controllers 121-122. The CPU 108 performs various kinds of processing operations by reading and executing an operations management program 201 which is stored in the memory 109 as shown in FIG. 2 to be later described. Additionally, the CPU 108 controls the display unit 110 to display information that requires interactions with a user in the process of executing various processing tasks. Further, CPU 108 processes the information as input from the input unit 111 through the interactions.

### Memory Arrangement in First Embodiment

FIG. 2 is a block diagram showing a configuration of the memory 109 on the storage management server 107 in the first embodiment of this invention. The memory 109 on storage management server 107 stores or “records” the operations management program 201 and an operations management database (DB) 202.

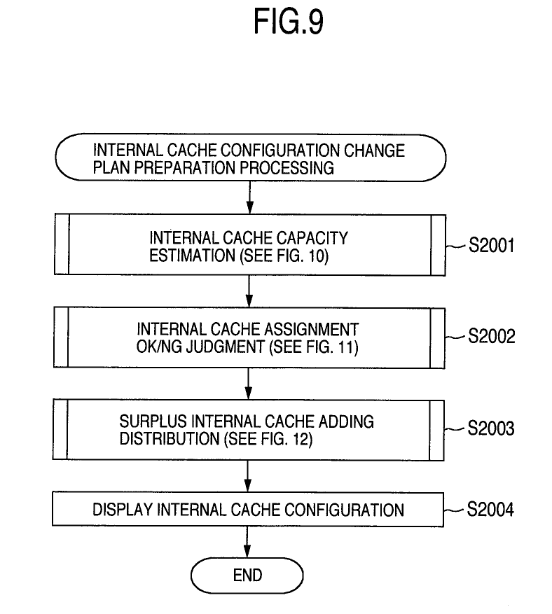

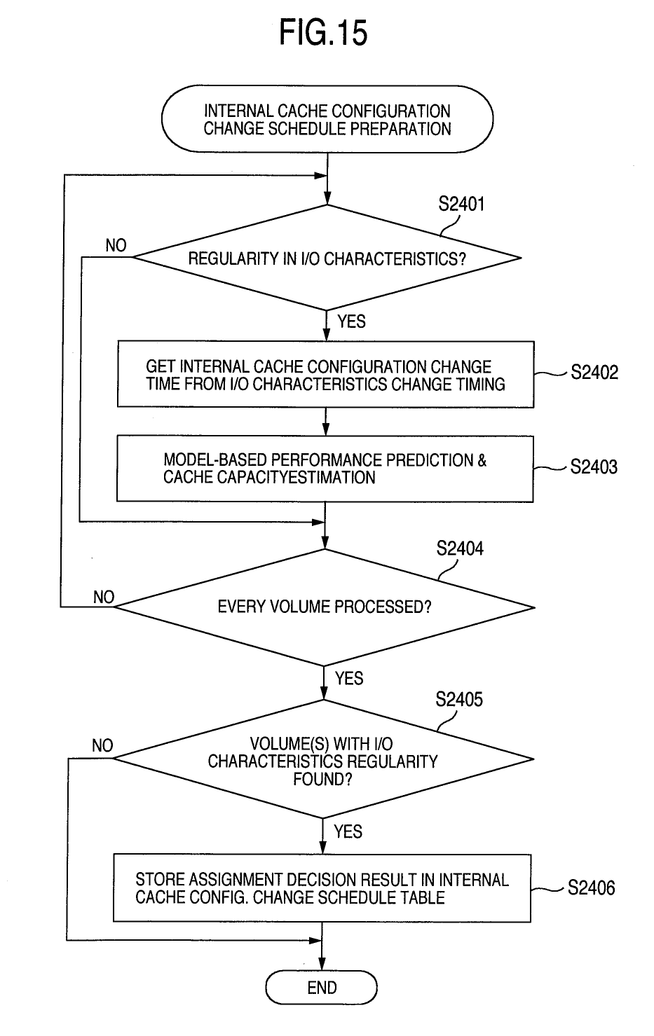

The operations management program 201 is generally made up of a cache configuration information collecting program 1001, access performance information collecting program 1002, policy definition information setup program 1003, internal cache configuration change plan preparing program 1004 (see FIG. 9), internal cache configuration change executing program 1013, and internal cache configuration change schedule preparing program 1014 (see FIG. 15).

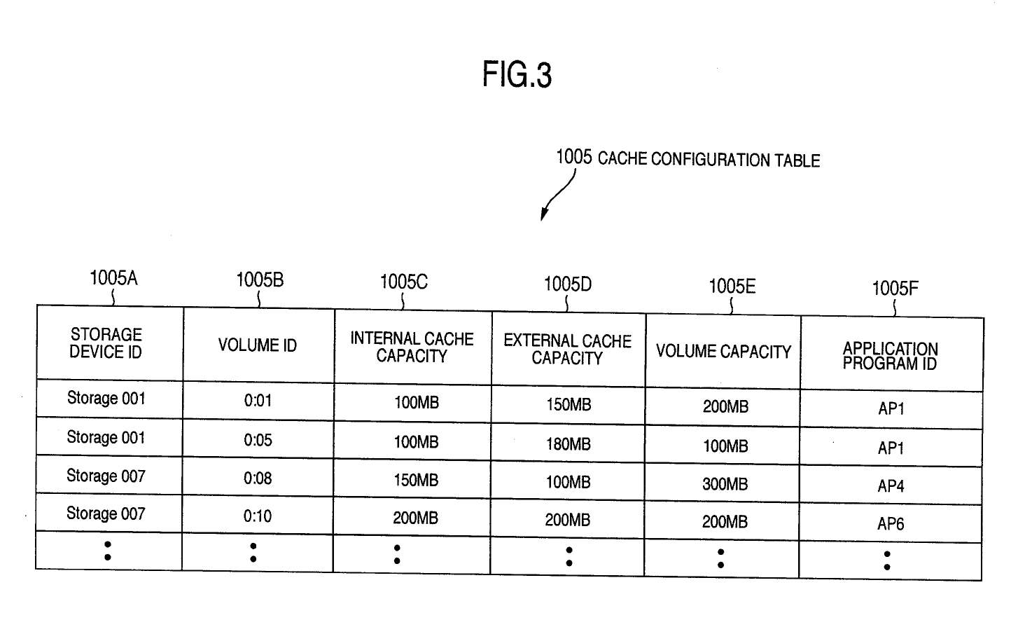

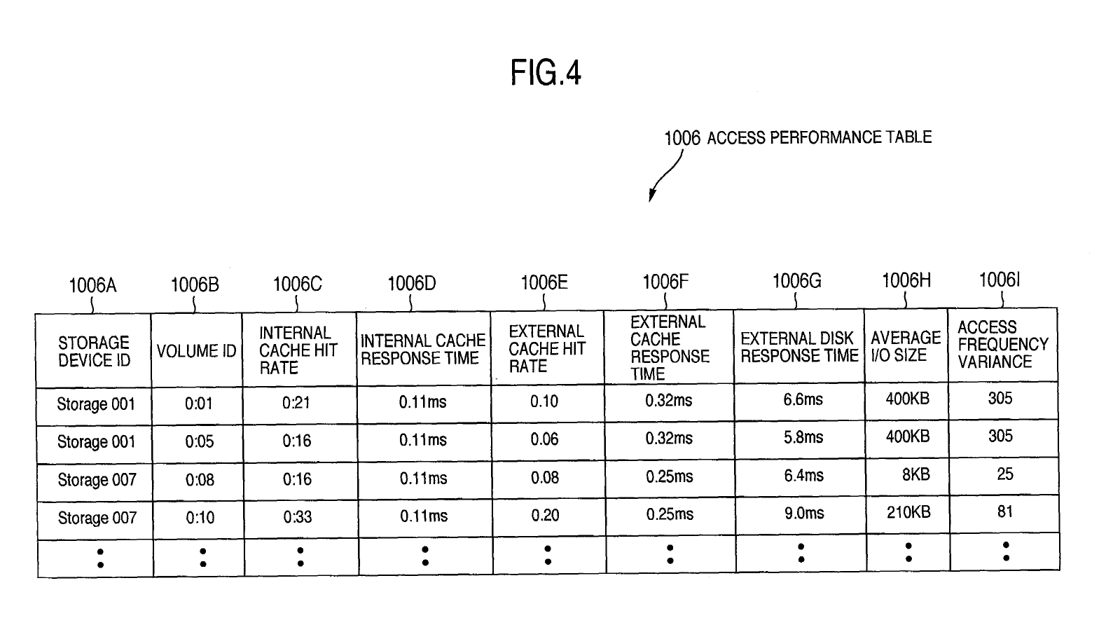

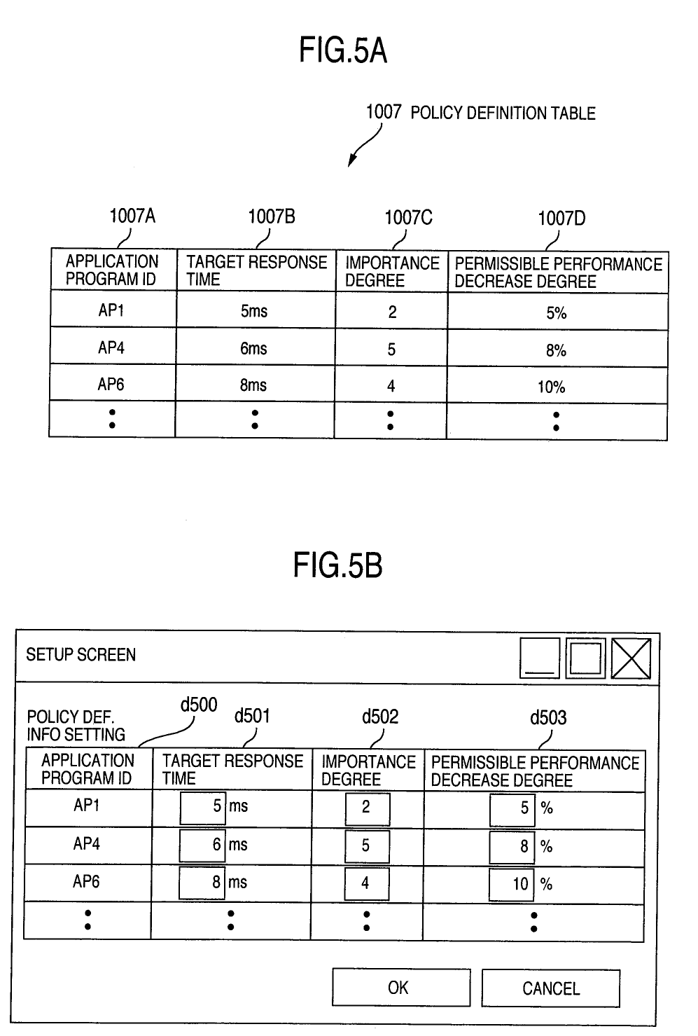

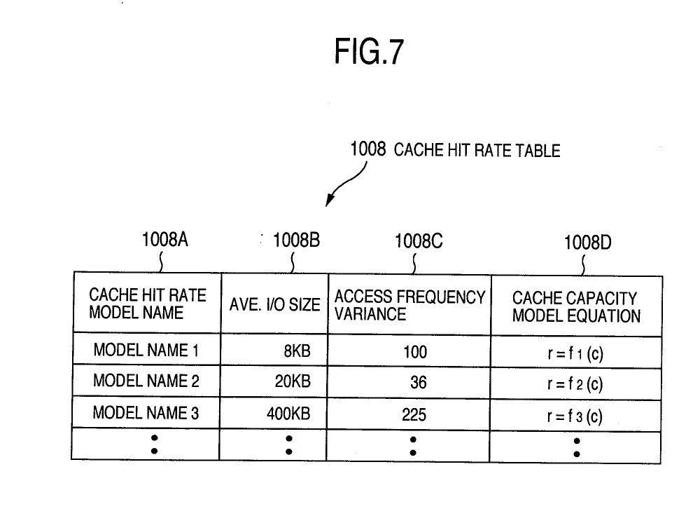

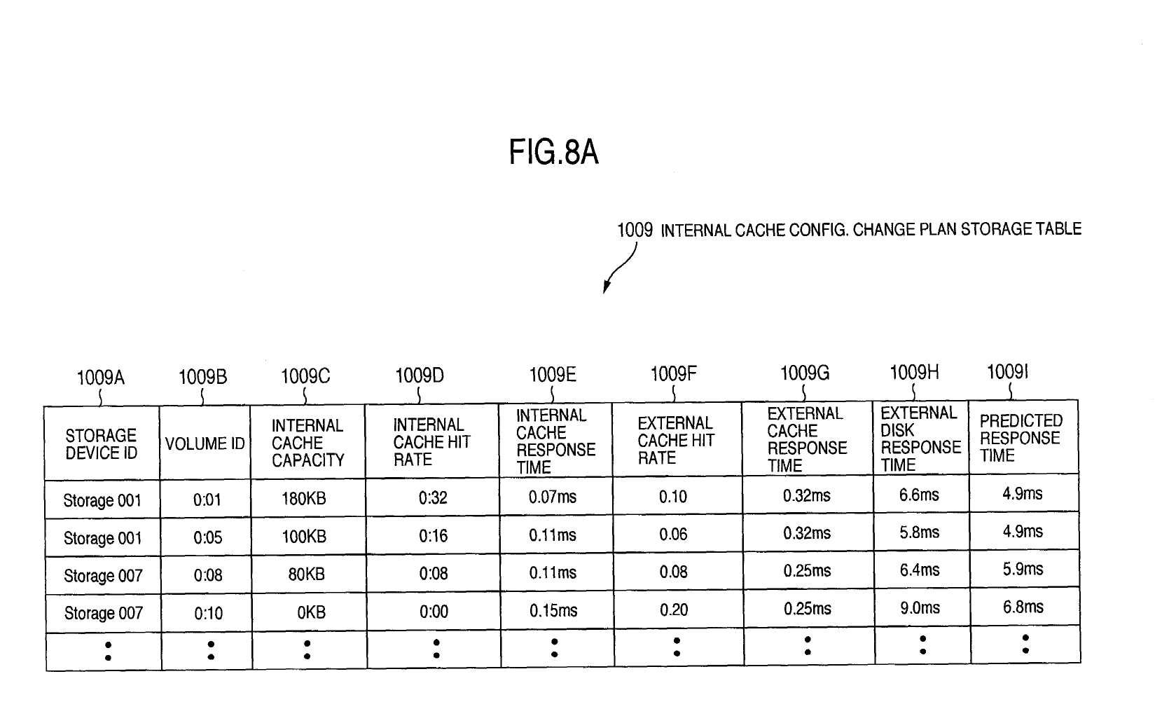

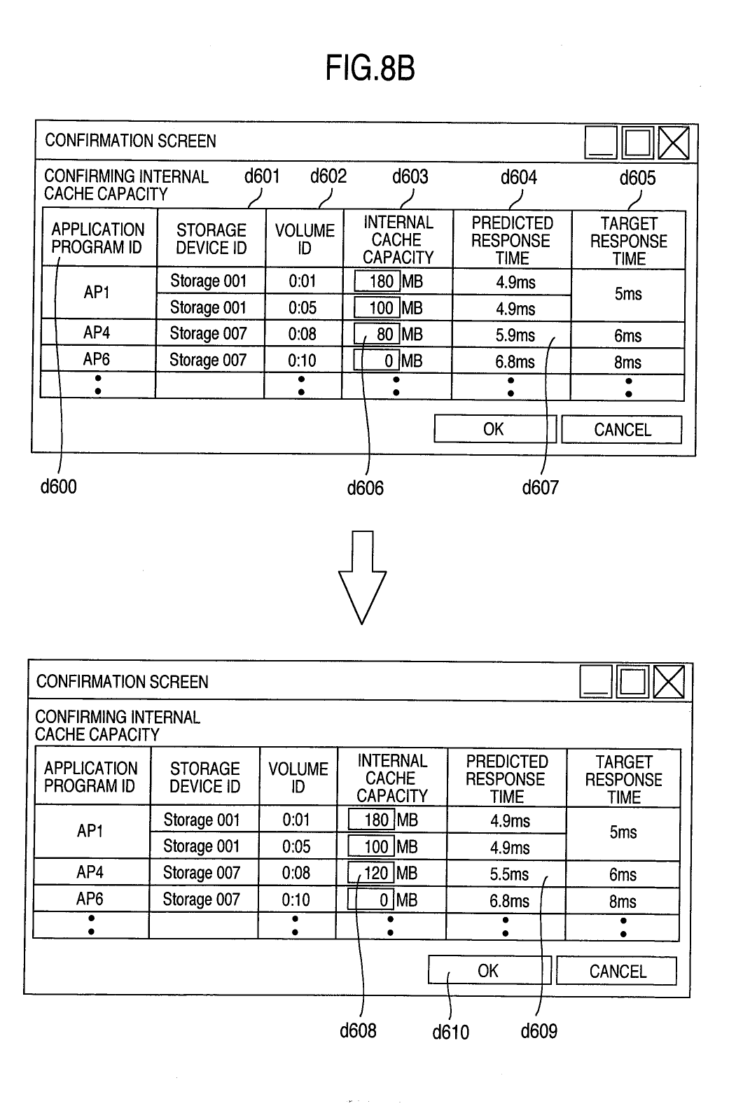

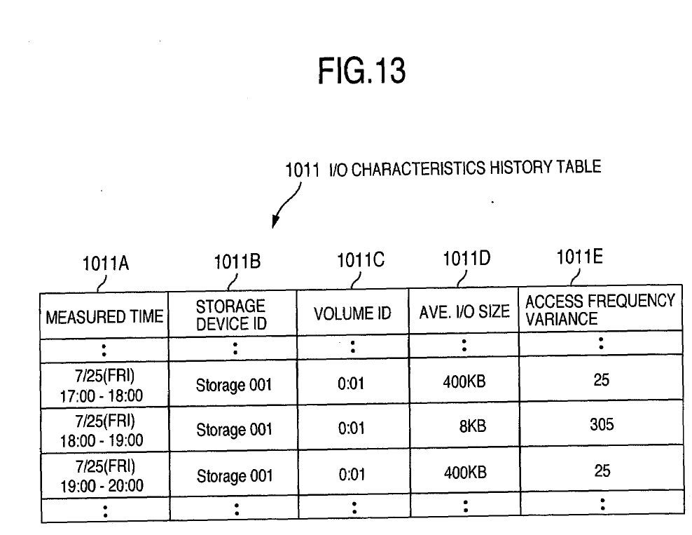

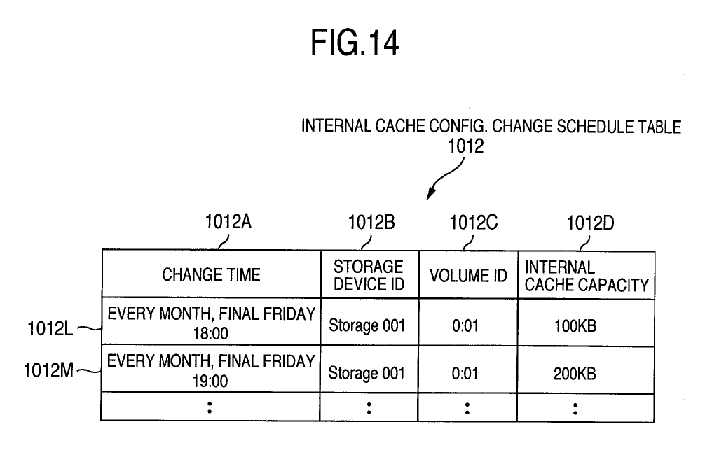

The operations management DB 202 is constituted from a cache configuration table 1005 (see FIG. 3), access performance table 1006 (see FIG. 4), policy definition table 1007 (see FIG. 5A), cache hit rate table 1008 (see FIG. 7), internal cache configuration change plan storage table 1009 (see FIG. 8A), input/output (I/O) characteristics history table 1011 (see FIG. 13), and internal cache configuration change schedule table 1012 (see FIG. 14).

### (Cache Configuration Information Collecting Program)

The cache configuration information collecting program 1001 collects information concerning an external cache capacity that is assigned to a logical volume 126 and an internal cache capacity that is assigned to a virtual volume 125 corresponding to the logical volume 126 and stores the collected information in the cache configuration information table 1005.

Further, this program adds an application program ID which enables the application program 102 to be uniquely identified based on the information of application program 102 as has been sent from the agent 127 of each application server 101. This application program ID is also stored in the cache configuration table 1005. Regarding the information as to assignment of an internal cache capacity, it collects information to be sent from the controller 121 within the virtualization apparatus 105. As for the information about assignment of an external cache capacity, it collects information to be sent from the controller 122 in storage device 106.

Generally, the application program 102 and the virtual volume 125 are correlatable together in a one-to-one correspondence manner by using information of three layers as will be next described. The three layers are a layer of from the application program 102 to a file system, a layer of from this file system to a logical unit number (LUN), and a layer of from the LUN to virtual volume 125.

Firstly, in the layer of from the application program 102 to the file system, the one-to-one correspondence relationship of the application program 102 and the file system is collected by the user's manual data input or by the agent 127's disk I/O monitoring or by use of an exclusive-use agent 127 capable of recognizing the configuration information of the application program 102. Next, in the layer of from the file system to LUN, the agent 127 establishes such correspondence relation by using the configuration information of an operating system (OS).

Lastly, in the layer of from the LUN to virtual volume 125, the corresponding correlation is performed based on the information as collected from the controller 121 of the virtualization apparatus 105. Based on the information items which were gathered from these three layers, the cache configuration information collecting program 1001 manages the correspondence relationship between the application program 102 and the virtual volume 125.

### (Access Performance Information Collecting Program)

The access performance information collecting program 1002 collects an internal cache hit rate of each virtual volume 125 from the controller 121 and also collects an external cache hit rate thereof from the controller 122. In addition, this program obtains by means of the controller 121 an average I/O size of data at the time that the application server 101 issues a write-in or read-out command to the virtualization apparatus 105 along with a variance of the access frequency of unit-size data of such the data, and then stores them in the access performance table 1006. It should be noted that the variance of the access frequency may be obtained by the agent 127 or, alternatively, may be obtained by the access performance information collecting program 1002 based on the information collected from the controller 121 or the agent 127.

Regarding the response time at the time of cache hitting to the internal cache 123 (referred to as “internal cache response time” hereinafter) and the response time upon cache hitting to an external cache 124 (called the “external cache response time) and the response time upon accessing to logical volume 126 (say “external disk response time”), the access performance information collecting program 1002 prestores therein the performance value on a per-storage device basis; so, this value is used. Details of it will be described later.

### (Policy Definition Information Setup Program)

The policy definition information setup program 1003 permits the user to input both an aimed or “target” response time (target performance value) to be obtained by the application program 102 on application server 101 and an importance degree of the application program 102 and also a permissible performance degradation degree in an event of transferring to a virtualized environment from non-virtual or “real” environment. These input values are then stored by the policy definition information setup program 1003 in the policy definition table 1007. Details of this table will be described later.

### (Internal Cache Configuration Change Plan Preparing Program)

The internal cache configuration change plan preparing program 1004 prepares a configuration change plan of the internal cache 123 of the virtualization apparatus 105 based on the target response time (target performance value) and importance degree of the application program 102 on application server 101 and the internal cache configuration of the virtualization apparatus 105 and also the external cache configuration of storage device 106. The internal cache configuration as used herein refers to an amount of the cache capacity which is assigned to each virtual volume 125. Similarly, the external cache configuration means an amount of the cache capacity assigned to each logical volume 126. Details will be stated later with reference to FIGS. 9 to 12.

### (Internal Cache Configuration Change Executing Program)

The internal cache configuration change executing program 1013 issues a cache configuration change request to the controller 121 of virtualization apparatus 105 based on the internal cache configuration plan that was prepared by the internal cache configuration change plan preparing program 1004 and then changes or “updates” a present configuration of the internal cache 123 of virtualization apparatus 105.

Although in this embodiment its description is given under an assumption that a cache is assigned to any one of the internal cache 123 of the virtualization apparatus 105 and the external cache 124 of storage device 106 with any one of the virtual volume 125 and the logical volume 126 being as a unit, it will also happen from time to time that such per-volume cache assignment is inexecutable due to limits of hardware, resulting in the assignment being done merely in units of array groups or in units of devices (virtualization apparatus 105 or storage device 106). Alternatively, for improvement of the cache use efficiency, there are cases where it is better to perform the cache assignment with a size-enlarged portion being as a unit, which portion is greater than the volume.

By taking these matters into consideration, the cache configuration change processing may be performed in a way which has the steps of organizing into a group those volumes which are included in the array group or the device or apparatus, obtaining a total value of cache capacities corresponding to respective volumes included in the group, and handing this total value as the cache capacity of the array group or the device.

### (Internal Cache Config Change Schedule Preparing Program)

The internal cache configuration change schedule preparing program 1014 predicts, based on a change in I/O characteristics of access from an application program 102, how the internal cache configuration is modified at which time point in order to enable the application program 102 to satisfy the target response time and then prepares a schedule. Details will be described with reference to FIG. 15 later.

### (Cache Configuration Table)

FIG. 3 is an explanation diagram showing the contents of the cache configuration table. The cache configuration table 1005 includes, as fields, a storage device ID 1005A capable of uniquely identifying the individual one of the storage devices 106, a volume ID 1005B capable of uniquely identifying a logical volume within storage device 106, an internal cache capacity 1005C of internal cache 123 which is assigned to a virtual volume 125 when a logical volume 126 is taken into the virtualization apparatus 105 side to be set as the virtual volume 125, an external cache capacity 1005D being assigned to each logical volume 126, a volume capacity 1005E, and an application program ID 1005F for unique identification of an application program 102 which is expected to use the virtual volume 125.

These contents of the cache configuration table 1005 are updated from the internal cache configuration change executing program 1013 whenever the internal cache configuration change executing program 1013 issues an internal cache configuration change request to the controller 121 of virtualization apparatus 105 and then the internal cache configuration was actually modified.

### (Access Performance Table)

FIG. 4 is an explanation diagram showing the contents of the access performance table. The access performance table 1006 includes as fields a storage device ID 1006A, a volume ID 1006B, an internal cache hit rate 1006C, an internal cache response time 1006D which is a time as taken for response to a application server 101 in the case of cache hitting to data on internal cache 123, an external cache hit rate 1006E, an external cache response time 1006F which is a time taken for responding to application server 101 in the case of cache hit to data on external cache 124, an external disk response time 1006G which is a response time to application server 101 upon failure of cache hit to the data on external cache 124, an average I/O size 1006H of access data from application server 101, and a variance 1006I of the frequency of access from application server 101.

The internal cache hit rate 1006C is collected from the controller 121 whereas the external cache hit rate 1006E is gathered from the controller 122. Regarding the internal cache response time 1006D and external cache response time 1006F, the access performance information collecting program 1002 holds in advance the information relative to the virtualization apparatus 105 and storage devices 106 of a plurality of vendors and multiple model types; so, such values are used.

The average I/O size 1006H is obtained in a way which follows: within a certain measurement time period (e.g., one hour or else), the controller 121 and agent 127 monitor input/output data during access from application program 102; then, a total value of I/O sizes is subtracted by an access number. The variance 1006I of the access frequency is obtained in a similar way to the average I/O size 1006H—that is, an access frequency variance is obtained with respect to each unit-size data based on an access number which was counted up per unit-size data of input/output data during access from application program 102 within a given measurement time period.

### (Policy Definition Table)

FIG. 5A is an explanation diagram showing the contents of the policy definition table. The policy definition table 1007 includes as fields an application program ID 1007A capable of uniquely identifying an application program 102, a target response time 1007B of the application program 102, a relative importance degree 1007C of application program 102, and a permissible performance decrease degree 1007D which indicates, upon transition of from a non-virtualized environment to virtualized environment, the permissibility of a predicted response time after completion of the transition to the virtual environment with respect to a response time which was measured in the non-virtual environment. Note that in this embodiment, the less the value of the importance degree, the more the importance.

### (Policy Definition Information Setup Screen)

FIG. 5B is an exemplary display screen showing a policy definition information setup method. FIG. 5B depicts a display screen example which is visually displayed on the screen of the display unit 110 when the user makes settings as to the target response time that is obtained by each application program 102, the importance degree of each application program 102 and the permissible performance decrease degree, which correspond to respective fields of the policy definition table 1007. In this display example, there are displayed an application program ID (d500), target response time d501, importance degree d502 and permissible performance decrease degree d503. It is possible for the user to set up the target response time d501, importance degree d502 and permissible performance decrease degree d503 with respect to application program 102 to be indicated by each application program ID (d500).

It is noted here that although this embodiment is arranged so that the target response time, importance degree and permissible performance decrease degree are settable individually, it is modifiable to employ a policy definition information setup program which functions to determine the permissible performance decrease degree d503 based on the importance degree d502 or, alternatively, determine the target response time d501 based on the importance degree d502.

### (Basics of Cache Capacity and Cache Hit Rate)

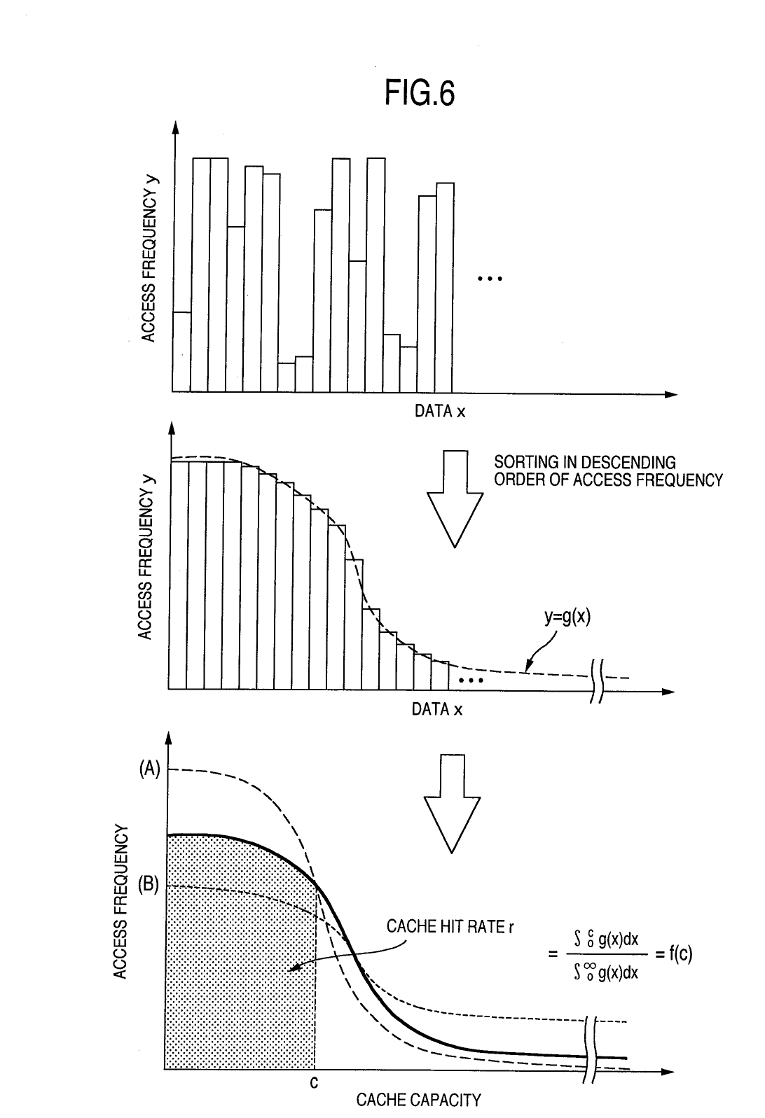

FIG. 6 is an explanation diagram showing basic concepts concerning the cache capacity and cache hit rate. Note that the one that is explained here is one exemplary approximation technique for rough computation, and other similar suitable schemes may alternatively be used. FIG. 6 shows three separate graphs at its upper, middle and lower parts, which will be explained in this order of sequence.

The graph at upper part of FIG. 6 is the one that shows an access frequency (access number) per unit-size data within a volume. It is the graph at middle part that sorted them in order of descending access frequency—i.e., from the highest to lowest value. Let y=g(x) be a curve which tied together such sorted access frequency values. Assuming here that the abscissa axis of the graph (solid line) at lower part is regarded as the internal cache capacity to be assigned, the cache hit rate r at the time of assigning a certain cache capacity may be represented by an area in a range of from 0 to c of y=g(x) with respect to an entire area of y=g(x). Letting this be f(c), a relationship of the cache capacity and cache hit rate may be given as r=f(c).

In this equation, an increase in cache capacity results in a likewise increase in cache hit rate. In case there is a deviation or “bias” in data to be accessed within a volume (equivalent to a broken line (A)), in other words, in case the access frequency's variance is large, an increase in cache capacity does not lead to appreciable improvement of the cache hit rate in view of the fact that the cache hit rate is kept high even when the cache capacity is small. Thus it can be said that while the cache hit rate is large in increase when the cache capacity is less, the cache hit rate's increase becomes smaller when the cache capacity becomes larger.

On the other hand, in case there is no bias in the data to be accessed within the volume so that access is given evenly, i.e., when the access frequency's variance is small (equivalent to a broken line (B)), an increase of the cache capacity leads to improvement of the cache hit rate commensurate therewith although the cache hit rate is not so high when the cache capacity is small. Thus it can be said that while the increase of the cache hit rate is less when the cache capacity is small, its increase does not appreciably vary even in case the cache capacity becomes larger whereas it does not become so small when compared to the case of the variance being large. Note here that although the parameter c is dealt as the cache capacity to be assigned, similar results are obtainable by using a ratio of the cache capacity to volume capacity as the parameter in place of the cache capacity.

### (Cache Hit Rate Table)

FIG. 7 is an explanation diagram showing the contents of cache hit rate table 1008. The I/O characteristics of application program 102 have a large number of attributes including, but not limited to, the I/O size of data, variance of access with respect to data, whether the data access of interest is random access or sequential access, and which one of writing and reading operations is greater in number. This invention is based on the concept which follows: those application programs 102 which are similar in I/O characteristics to each other are capable of being approximated by use of a similar correlation model(s) in terms of correlative models of the cache capacity and cache hit rate.

As has been stated in the explanation of FIG. 6, it is considered that the curve which indicates the relationship of the cache capacity versus cache hit rate in case the access frequency's variance is large and the curve that indicates the relationship of the cache capacity and cache hit rate in case the access frequency variance is small become different curves having different features. Additionally, although in this invention an explanation will be given by taking as examples of the I/O characteristics the average I/O size and the access frequency variance, no serious problems occur for implementation of this invention when using other kinds of attributes.

The cache hit rate table 1008 is the one that was obtained by modelization of the relationship of the cache capacity and cache hit rate based on the above-stated I/O characteristics (i.e., average I/O size and access frequency variance), and includes fields of a cache hit rate model name 1008A for unique identification of a model, an average I/O size 1008B, an access frequency variance 1008C, and a cache capacity model equation 1008D which numerically convert or “mathematizes” the cache capacity and cache hit rate. The cache hit rate table 1008 is the one that is prepared at a time point that the operations management program 201 is installed in the storage management server 107, although no serious problems occur in this embodiment even when the user uses measurement values during operations to tune up the correlation model or to make a new model.

### (Internal Cache Configuration Change Plan Storage Table)

FIG. 8A is an explanation diagram showing the contents of the internal cache configuration change plan storing table. The internal cache configuration change plan storage table 1009 is a table which stores therein data indicative of an internal cache to be assigned and a predicted response time in the case of assignment of the internal cache capacity, wherein a record is prepared by internal cache configuration change processing as will be described later.

The internal cache configuration change plan storage table 1009 includes as fields a storage device ID 1009A, volume ID 1009B, internal cache capacity 1009C, internal cache hit rate 1009D, internal cache response time 1009E, external cache hit rate 1009F, external cache response time 1009G, external disk response time 1009H, and predictive response time 1009I which takes into consideration respective response time values in those events of internal cache hitting, external cache hit and external disk access.

The internal cache capacity 1009C is an estimated value of the internal cache capacity which is necessary in order to satisfy the performance that is expected by the policy definition information of application program 102. In case the internal cache capacity 1009C is zero megabyte (OMB), it indicates that the expected performance is satisfied without having to assign any internal cache. In this embodiment, a negative value such as “−1 MB” as an example is set for the internal cache capacity 1009C in order to represent that the expected performance is not satisfiable in any way even when assigning a sufficiently large amount of internal cache capacity, although similar results are also obtainable by adding another field to provide such representation. Details will be described later.

### (Internal Cache Config Change Plan Verify/Reset Screen)

FIG. 8B is an exemplary display screen showing an internal cache configuration change plan verify/resetting method. Shown herein is an on-screen display image example for presenting the contents of internal cache configuration change plan storage table 1009 to the user through a display screen and for enabling the user to verify a presently set cache capacity and allowing the user to redo value settings if necessary.

In this display screen example, there are shown an internal cache capacity d603 which is allocated to the storage device ID (d601) to be accessed by an application program 102 with an application program ID (d600) being allocated thereto and the virtual volume 125 corresponding to logical volume 126 having a volume ID (d602), a predictive response time d604 of the volume upon allocation of such internal cache capacity, and a target response time of the application program 102. On this display screen, the user is allowed to change the internal cache capacity d603. When the user performs such value change, the predictive response time d604 will be automatically recalculated and displayed in a way as will be described later.

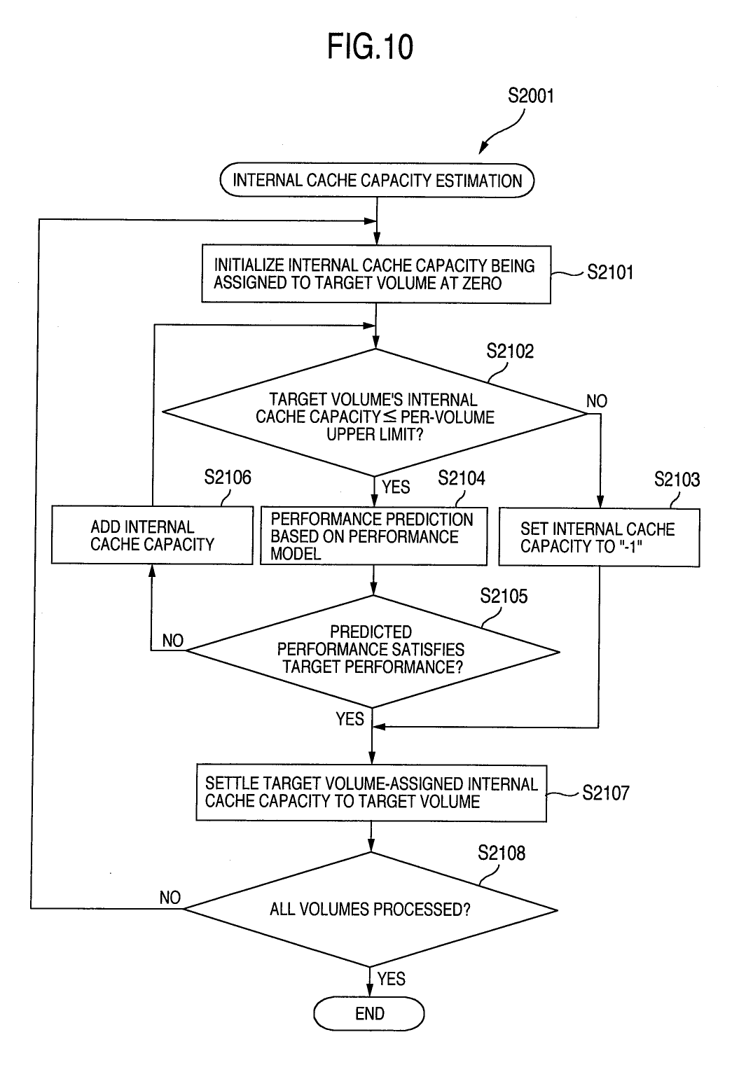

For example, in case the internal cache capacity is 80 MB (d606) and the predictive response time d604 is 5.9 ms (d607), when the internal cache capacity is changed to 120 MB (d608), a predictive response time d604 for this changed internal cache capacity 123 is recalculated, resulting in an indication of “5.5 ms” (d609) being displayed. A method of the recalculation will be described later at a step S2104 (see FIG. 10). The value that was changed here is reflected in the internal cache configuration change plan storage table 1009.

Note that in case the internal cache capacity 1009C of the internal cache configuration change plan storage table 1009 is a negative value, the internal cache capacity d603 is displayed like a blank cell, which indicates that it was unable to estimate any optimal internal cache capacity value that satisfies the target response time. Additionally, by clicking on an “OK” button d610 in this display screen, the internal cache configuration change executing program 1013 is called up, which issues an internal cache configuration change request to the controller 121 of the virtualization apparatus 105 in accordance with the configuration change plan that is stored in the internal cache configuration change plan storage table 1009, followed by modification of the internal cache configuration.

### (I/O Characteristics History Table)

FIG. 13 is an explanation diagram showing the contents of the I/O characteristics history table. The I/O characteristics history table 1011 includes fields of an I/O characteristics measurement time 1011A, storage device ID 1011B, volume ID 1011C, average I/O size 1011D and access frequency variance 1011E in relation to unit-size data of the data to be accessed from application server 101.

Based on this I/O characteristics history table 1011, search or “exploration” is performed to determine whether there is regularity in changes of I/O characteristics of each volume. If the regularity is found, the internal cache configuration is changed at a time point immediately before the time of a regularly occurring change, e.g., a specific date, a day of the week, a time slot or else, wherein a cache capacity which is best fit to the periodically varying I/O characteristics has been obtained in advance. In FIG. 13, there is shown a case where an application program 102 for a volume with the storage device ID 1011B being set at “Storage001” and with the volume ID 1011C being “0:01” is changed in its I/O characteristics.

More specifically, the I/O characteristics with the average I/O size 1011D and access frequency variance 1011E having been set at “400 kB” and “25” respectively within a measurement time period of “17:00-18:00, Friday, July 25” is such that the average I/O size 1011D and access frequency variance 1011E are changed to “8 KB” and “305” respectively within a time period of “18:00-19:00, Friday, July 25”—further, the average I/O size 1011D and access frequency variance 1011E are returned to “400 KB” and “25” respectively within a following time period of “19:00-20:00, Friday, July 25.”

### (Internal Cache Configuration Change Schedule Table)

FIG. 14 is an explanation diagram showing the contents of the internal cache configuration change schedule table. The internal cache configuration change schedule table 1012 includes fields of a change start time 1012A which is a time point or period for start-up of cache configuration change, a storage device ID 1012B for enabling unique identification of a storage device 106, a volume ID 1012C for enabling unique distinction of a logical volume within the storage device 106, and a changed internal cache capacity 1012D.

Rows 1012L and 1012M of FIG. 14 are schedules which are prepared by the internal cache configuration change schedule preparing program 1014 in accordance with the above-stated changes in I/O characteristics of FIG. 13. More precisely, this means that a specific amount—here, “200 MB”—of internal cache 123 is assigned to the virtual volume 125 that is periodically performing mapping the storage device ID of “Storage001” and volume ID of “0:01” within the virtualization apparatus 105 at “18:00 of final Friday in every month.” Details will be described later.

Next, an explanation will be given of main processing. The processing of the cache configuration management system of storage device in this embodiment is dividable into internal cache configuration change plan preparation processing (see FIG. 9 to FIG. 12) and I/O characteristics-based internal cache configuration change schedule preparation processing (see FIG. 15). Each processing will be explained in detail below.

### (Internal Cache Config Change Plan Preparation Processing)

FIG. 9 is a flow chart showing the internal cache configuration change plan preparation processing. This processing shown in FIG. 9 is executed in such a way that the CPU 108 (see FIG. 1) reads the internal cache configuration change plan preparing program 1004 into the memory 109. This internal cache configuration change plan preparation processing is arranged to be executed in response to receipt of an execution command from the input unit 111 as manually entered by the user, although it may alternatively be altered to be executed at a preset time of day in an automated way.

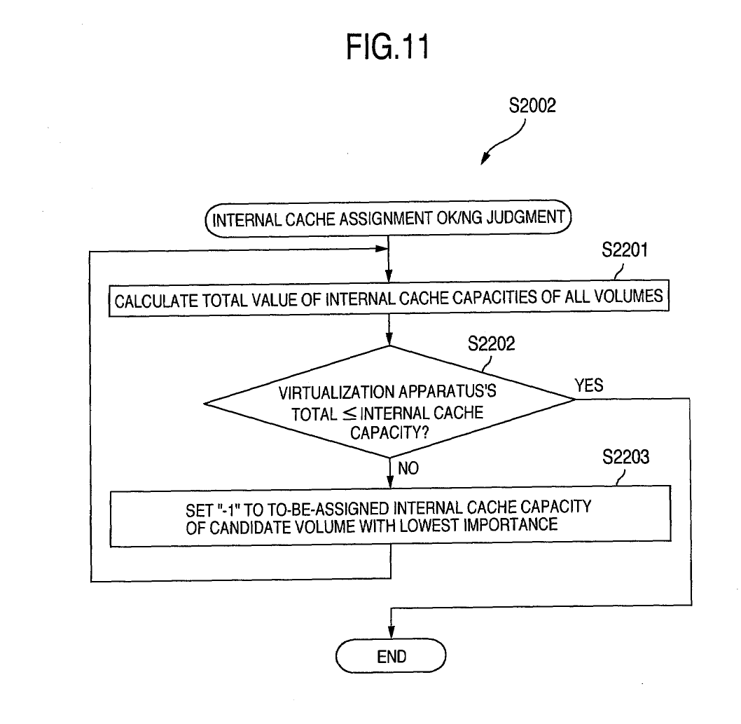

At step S2001 of FIG. 9, the CPU 108 performs estimation processing of the internal cache capacity of the virtualization apparatus 105 (see FIG. 10). At a subsequent step S2002, the CPU 108 performs processing for determining whether the internal cache capacity that was estimated at step S2001 is actually within the range of internal cache capacity which is built in the virtualization apparatus 105 (see FIG. 11). If it fails then CPU 108 performs adjustment of the internal cache assignment capacity.

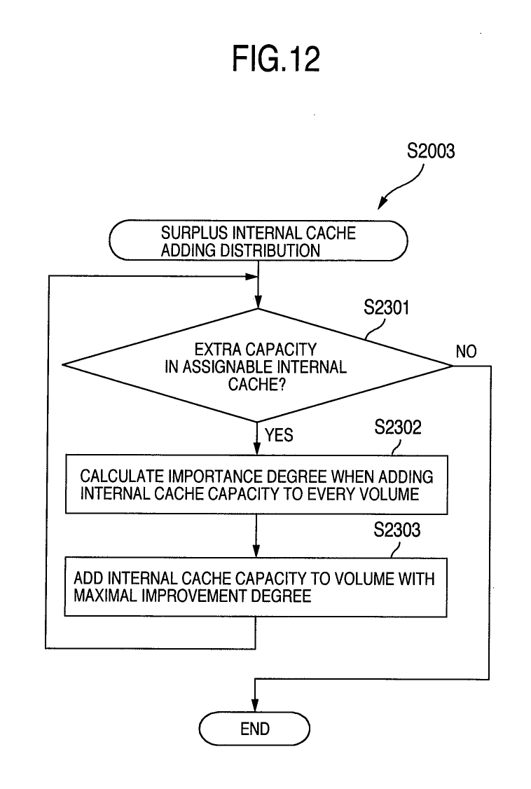

Subsequently at step S2003, the CPU 108 judges whether the internal cache capacity that was estimated at step S2001 is less than the internal cache capacity that is actually built in the virtualization apparatus 105. If so, then perform distribution processing (see FIG. 12) for adding a surplus or “idle” cache to the virtual volume 125 of virtualization apparatus 105.

Lastly, at step S2004, the CPU 108 performs visual displaying of the resulting internal cache configuration. By means of the verify screen shown in FIG. 8B, the user confirms the internal cache configuration and, if necessary, changes the internal cache capacity to be assigned and/or the internal cache configuration using the controller 121 of virtualization apparatus 105. In case the internal cache configuration change processing is executed at a preset time of day, the user's verify process is omitted, and the display contents here—i.e., the contents of internal cache configuration change plan storage table 1009—are used directly to call for the controller 121 of virtualization apparatus 105 to thereby perform the internal cache configuration change.

### (Internal Cache Capacity Estimation Processing)

FIG. 10 is a flowchart showing internal cache capacity estimation processing. The internal cache capacity estimation processing is performed with respect to each virtual volume 125 of the virtualization apparatus 105. In this estimation processing here, an internal cache capacity is obtained, which is the smallest among those capacities satisfying the target performance. Although the processing entity is the CPU 108, its parts name will be omitted in an explanation below.

First, at step S2101, the internal cache capacity that is assigned to the aimed or “target” virtual volume 125 is initialized to zero (0). At its subsequent step S2102, it is verified whether the internal cache capacity assigned to target virtual volume 125 is less than or equal to an upper limit value per volume (whether the former exceeds the latter). The upper limit value here may be set to a fixed ratio with respect to a total capacity amount of the internal cache 123 which is built in the virtualization apparatus 105 or, alternatively, may be set at a fixed ratio of the volume capacity of this virtual volume 125. Here, when it is not less than the per-volume upper limit value (i.e., if “No” at step S2102), it is determined that the target performance cannot be satisfied even when assigning a sufficient amount of internal cache capacity. Then, the procedure proceeds to step S2103, which sets the to-be-assigned internal cache capacity to a negative value (e.g., −1 MB); then, go to step S2107.

Next, when the to-be-assigned internal cache capacity is less than or equal to the per-volume upper limit value at step S2102 (i.e., if “Yes” at step S2102), the procedure goes to step S2104, which performs performance prediction based on a performance model. From the access performance table 1006 (see FIG. 4), an average I/O size 1006H (μ_{IO}) corresponding to the target virtual volume 125 and access frequency variance 1006I (δ²_{freq}) are acquired; a model with the maximal similarity is selected from the cache hit rate table 1008 (see FIG. 7). Examples of the method for selecting the maximal-similarity model include a method which lets a value Δ in an equation below be the one with maximum similarity. Note here that in Equation (A1) below, coefficients a and b may be set to fixed values in the system or, alternatively, may be tuned by using performance measurement results or the like. In this equation, μ_{model} refers to the average I/O size 1008B in a model existing in the cache hit rate table 1008, and δ²_{model} is the value of access frequency variance 1008C in this model.

Δ=a(μ_{model}−μ_{IO})²+b(δ²_{model}−δ²_{freq})² (A1)

From the model equation 1008D of the cache capacity that was judged to have the maximum similarity in the way stated above, there are obtained an internal cache hit rate ri corresponding to the internal cache capacity and an external cache hit rate re corresponding to an external cache capacity in the case of the internal cache capacity being assumed to be zero. A predictive response time for use as the performance prediction value at this time is obtainable using the values of the cache configuration table 1005 (see FIG. 3) and access performance table 1006 (see FIG. 4) in a way which follows.

In case the internal cache capacity is smaller than the external cache capacity 1005D, the predictive response time is given by Equation (A2) by taking into consideration the case of hitting to an external cache:

ri×ti_{1006D}+((re−ri)×re_{1006E})+((1−re)×de_{1006G}) (A2)

where ri is the internal cache hit rate, re is the external cache hit rate, ti_{1006D} is an internal cache response time indicated by the set value 1006D in access performance table 1006, re_{1006E} is an external cache hit rate indicated by the value 1006E in table 1006, and de_{1006G} is an external disk response time indicated by 1006G.

When the internal cache capacity is larger than the external cache capacity 1005D, it is very likely that there are no cases where the external cache hitting takes place. Thus, the predictive response time is given by Equation (A3) below:

ri×ti_{1006D}+((1−ri)×de_{1006G}) (A3)

At step S2105, a determination is made as to whether the predicted performance satisfies the target value. Concretely, the predictive response time that is the predicted performance as obtained at step S2104 is compared to the target response time 1007B of the policy definition table 1007, which is the target performance. At this time, the application program ID 1005F is obtained by referring to the cache configuration table 1005 (see FIG. 3) while letting the storage device ID 1005A corresponding to the target volume and its volume ID 1005B be keys, and the above-noted target response time is obtained with reference to a row in which the application program ID is congruent with the application program ID 1007A of the policy definition table 1007 (see FIG. 5A).

In case the predicted performance fails to satisfy the target performance (i.e., if No at step S2105), the routine proceeds to step S2106 which adds an internal cache capacity. Then, return to step S2102, which tries to perform the performance prediction again.

In case the predicted performance is able to satisfy the target performance (i.e., if Yes at step S2105), the routine goes to step S2107, which finally determines the internal cache capacity to be assigned to the target volume. This final decision result is stored in the internal cache configuration change plan storage table 1009 (see FIG. 8A). At this time, the internal cache capacity 1009C, internal cache hit rate 1009D and external cache hit rate 1009F are the above-stated final decision result and those hit rates which were used for such final value settlement. Let the other fields be the same in value as their corresponding fields of the same names in a row in the access performance table 1006 (see FIG. 4), in which the storage device ID 1006A and volume ID 1006B are identical therewith.

Finally at step S2108, it is verified whether the internal cache capacity estimation has been completed with respect to every volume involved (whether the processing was performed or not). In case such is not completed yet (i.e., if No at step S2108), return to the step S2101. In case the processing has been completed (if Yes at step S2108), the internal cache capacity estimation processing is ended.

### (Internal Cache Assignment OK/NG Judgment Processing)

FIG. 11 is a flowchart showing internal cache assignment capable/incapable judgment processing. This internal cache assignment OK/NG judgment processing is the one that verifies whether the information of the internal cache configuration change plan storage table 1009 (see FIG. 8A) which is a result of the above-stated internal cache capacity estimation processing is within the actual range of a total capacity amount of the internal cache 123 of the virtualization apparatus 105 and, if it is out of the range, assigns the internal cache capacity to an application with a higher degree of importance while putting higher priority thereto. Although the processing hardware is the CPU 108, the use of its name will be eliminated in an explanation below.

Firstly, at step S2201, reference is made to the internal cache capacity 1009C in every row of the internal cache configuration change plan storage table 1009 (see FIG. 8A) to thereby obtain a sum of those having positive values. By doing so, a total value is obtained of to-be-assigned internal cache capacities with respect to all the virtual volumes involved. Subsequently, at step S2202, the total value obtained is compared to the capacity of the internal cache 123 that is built in the virtualization apparatus 105. If this total value is less than the built-in cache capacity (Yes at step S2202), the internal cache capacity 1009C of the internal cache configuration change plan storage table 1009 is entirely assignable; so, the processing is terminated.

In case the total value that was obtained at the step S2201 is larger than the total capacity of the internal cache 123 that is built in the virtualization apparatus 105 (i.e., if No at step S2202), the procedure goes to step S2203, which prevents internal cache assignment with respect to those volumes with lower importance degrees among the assignment-aimed volumes to thereby reduce the amount of the internal cache capacity to be assigned.

Practically, the internal cache configuration change plan storage table 1009 (see FIG. 8A) and the cache configuration table 1005 (see FIG. 3) are combined together by means of the storage device ID and volume ID whereas the cache configuration table 1005 (see FIG. 3) and the policy definition table 1007 (see FIG. 5A) are coupled together by the application program ID. A connection table is used to obtain a specific one which is positive in value of the internal cache capacity 1009C of internal cache configuration change plan storage table 1009 and simultaneously is maximal in level of the importance degree 1007C of policy definition table 1007. Then, for the obtained one that corresponds to the maximum importance degree 1007C, the internal cache capacity 1009C of internal cache configuration change plan storage table 1009 is set at a negative value (e.g., −1 MB); then, return to the step S2201.

### (Surplus Internal Cache Adding Distribution Processing)

FIG. 12 is a flowchart showing the processing for additional distribution of a surplus internal cache(s). This surplus internal cache adding distribution processing is the process that judges the amount of an additionally assigned internal cache capacity by taking account of a degree of improvement at the time of adding an internal cache in order to improve the performance in an entirety of the storage system in a case where the above-stated internal cache capacity estimation processing results in a remainder being generated in the capacity of the internal cache 123 that is built in the virtualization apparatus 105. Note here that the additional distribution processing is not essential, and an alternative technique is also employable for letting the surplus internal cache remain for later use in internal cache configuration change schedule preparation processing based on I/O characteristics to be later described. While the processing hardware is the CPU 108, its parts name will be omitted in an explanation below.

First, at step S2301, an attempt is made to check whether there is a capacity with no schedule for assignment in the internal cache 123 that is built in the virtualization apparatus 105. Practically, by referring to the internal cache capacity 1009C in every row of the internal cache configuration change plan storage table 1009 (see FIG. 8A), a sum of those having positive values is obtained; then, this value is compared to the total capacity amount of the built-in internal cache 123 of virtualization apparatus 105. In case the sum is less than the total capacity, it is possible to determine that there is a remainder. If no such remainder is found (if No at step S2301) then the processing is ended.

When a remainder is found (if Yes at step S2301), go to step S2302 which calculates the importance degree in case internal cache capacity addition is done with respect to all the volumes involved. A size to be added at this time may be either a fixed value of the system or a value which was obtained by equally dividing a remaining amount of the internal cache by the fixed value of the system. A predictive response time in the case of an internal cache being added is computed by a method which is similar to that stated in the step S2104. The improvement degree of each volume is calculated by (pr₁−pr₂)/pr₁, where pr₁ is the predictive response time prior to the addition, and pr₂ is the predictive response time after the addition.

Subsequently, at step S2303, a decision is made to add the internal cache capacity to a volume which is the largest in improvement degree calculated at step S2302. Then, this result is reflected in the internal cache configuration change plan storage table 1009 (see FIG. 8A).

Note that another embodiment of the surplus internal cache adding distribution processing is conceivable, which is not the additional distribution based on the improvement degree in the case of internal cache addition but additional distribution pursuant to the importance degree 1007C of an application program 102. One example of it may be an importance degree-based proportional distribution method, wherein a cache capacity Cᵢ which is to be additionally distributed to a certain volume is obtainable, for example, by Equation (A4) below:

Cᵢ=Xᵢ/Σx*Cᵣₛₜ (A4)

where Cᵣₛₜ is the surplus cache capacity, and Xᵢ is the importance degree 1007C of an application program 102 in access to a volume.

### (Internal Cache Config Change Schedule Preparing Processing)

FIG. 15 is a flowchart showing I/O characteristics-based internal cache configuration change schedule preparing processing. The I/O characteristics history table 1011 (FIG. 13) is used to judge whether regularity is present or absent. When the regularity is found, a schedule is prepared for performing alteration or “update” of the cache configuration at a suitable timing in conformity with such regularity. Although the processing hardware is the CPU 108, its parts name will be omitted in an explanation below.

At step S2401 in FIG. 15, whether there is a change with regularity in the I/O characteristics is detected. An example of the change with regularity is a periodical change in I/O characteristics occurring within a specific time-of-day of a specific day of every week. Exemplary approaches to detecting such “regular” change include a method having the steps of picking up all measurement time periods each of which exhibits changes in measured average I/O size and access frequency variance that are both greater than or equal to a certain ratio (e.g., 20%) and then examining them to determine whether there is commonality therebetween in a view point of date-and-time or a day of the week or the like. In case no such regularity is found in measured values (i.e., if No at step S2401), the I/O characteristics-based internal cache configuration change schedule preparation processing is ended. In case the regularity is found (if Yes at step S2401), proceed to step S2402. At this step, a time point for modifying the cache configuration is obtained based on a timing at which a change in I/O characteristics occurs.

At step S2403, a predictive response time of the target volume is obtained based on the I/O characteristics, followed by calculation of an internal cache capacity which becomes necessary within the time period or “slot.” This internal cache capacity calculation is substantially the same as a process of from the step S2101 to step S2106 shown in FIG. 10. At step S2404, judgment is made as to whether the processing has been done for every volume involved. In case an unprocessed volume is found (i.e., if No at step S2404), the processing is repeated from the step S2401. In case the processing has already been done for every volume (if Yes at step S2404), proceed to step S2405.

At step S2405, a decision is made as to whether there is/are one or more volumes with regularity in I/O characteristics. In case there is no single volume which was determined to have regularity in the processing of step S2401 (if No at step S2405), this processing is ended. In case there is at least one volume with the regularity (if Yes at step S2405), go to step S2406.

At step S2406, the time point that was obtained per group at step S2402 and the internal cache capacity that was obtained at step S2406 are stored in the internal cache configuration change schedule table 1012 (see FIG. 14). The internal cache configuration change processing relative to the controller 121 of the virtualization apparatus 105 corresponding to each row stored in the internal cache configuration change schedule table is assumed to be executed at the time-of-day that was designated by a general OS-provided task management function or the like, although similar results are also obtainable by arranging the operations management program 201 to include therein a task management-use software program.

Note that while this flowchart is shown under an assumption that the cache capacity that becomes necessary in the internal cache configuration changing process is sufficiently retained in advance, per-volume internal cache assignment OK/NG judgment may alternatively be performed by taking into consideration the entire capacity amount of the internal cache 123 that is built in the virtualization apparatus 105 as has been indicated in the internal cache assignment OK/NG judgment processing of FIG. 11.

### Second Embodiment

In the first embodiment, the internal cache capacity within virtualization apparatus which is assigned to a virtual volume in the case of letting the logical volume in an externally connected storage device be taken into the virtualization apparatus side for use as the virtual volume has been described. In a second embodiment, an explanation will be given of internal cache capacity estimation to be performed when newly introducing a virtualization apparatus into an environment with no virtualization apparatus being present therein. Note here that explanations of processings similar to those of the first embodiment will be eliminated, and its different points from the first embodiment will mainly be stated below.

### System Arrangement in Second Embodiment

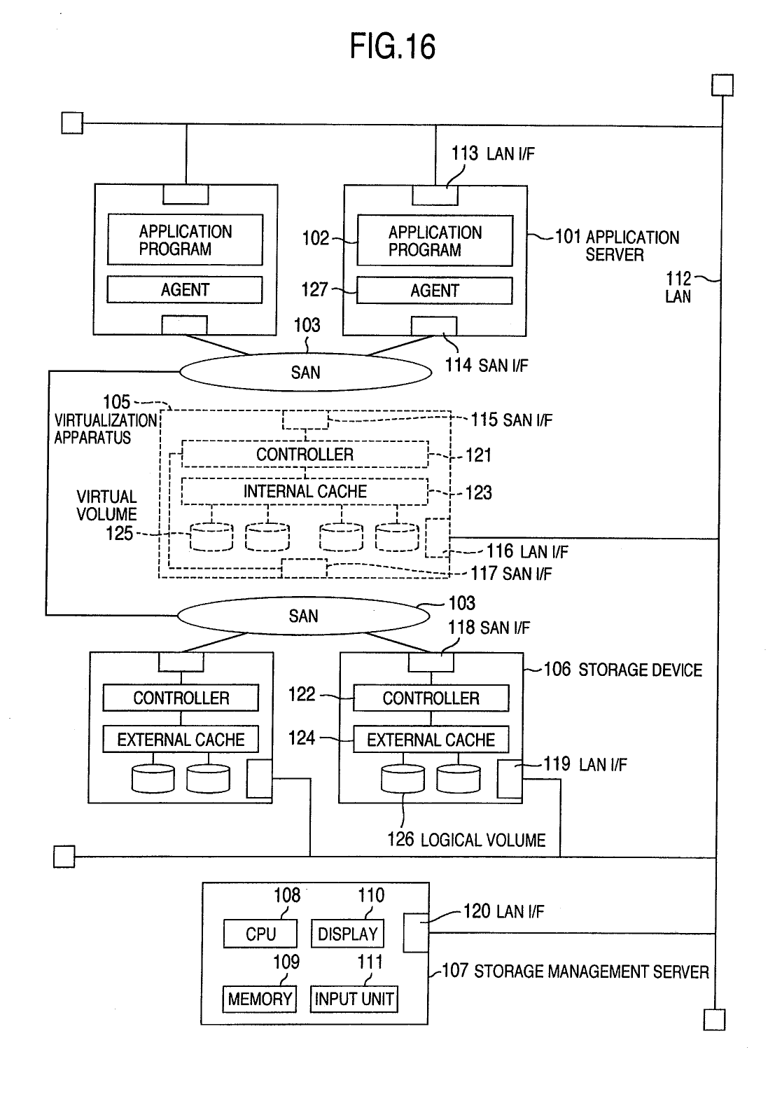

FIG. 16 is a block diagram of a storage system in accordance with the second embodiment of this invention. A difference of this system from that shown in FIG. 1A is that the virtualization apparatus 105 and storage area network (SAN) 104 of FIG. 1A are not included therein. Due to this, the application server 101 is arranged to provide access to each storage device 106 via SAN 103 only. A block diagram of the storage system after introduction of virtualization apparatus becomes that shown in FIG. 1A.

### Memory Configuration in Second Embodiment

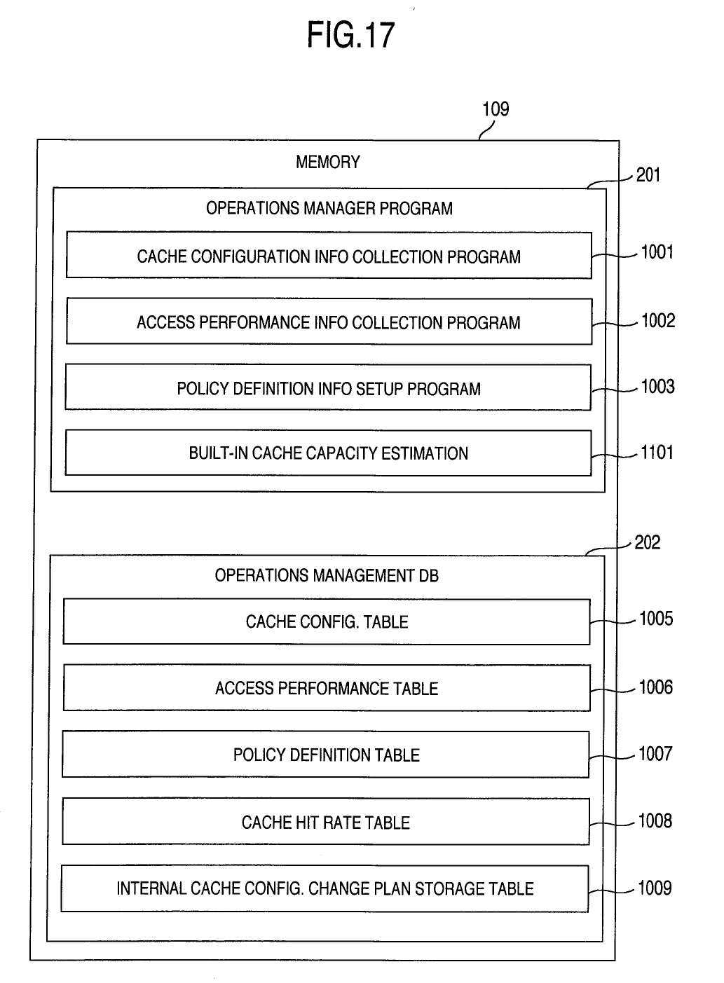

FIG. 17 is a block diagram of the configuration of a memory on a storage management server in the second embodiment of this invention. This is different from the memory on the storage management server 107 in the first embodiment (see FIG. 2) in the following points. The operations management program 201 of memory 109 does not include the internal cache configuration change plan preparing program 1004 but includes a built-in cache capacity estimation program 1101 as an alternative thereto. In addition, the operations management database (DB) 202 does not include the I/O characteristics history table 1011 and the internal cache configuration change schedule table 1012.

Note that in this embodiment, no values are stored in those fields of the internal cache capacity 1005C of cache configuration table 1005 (see FIG. 3) and the internal cache hit rate 1006C and internal cache response time 1006D of the access performance table 1006 (see FIG. 4).

### Response Time Evaluation Method

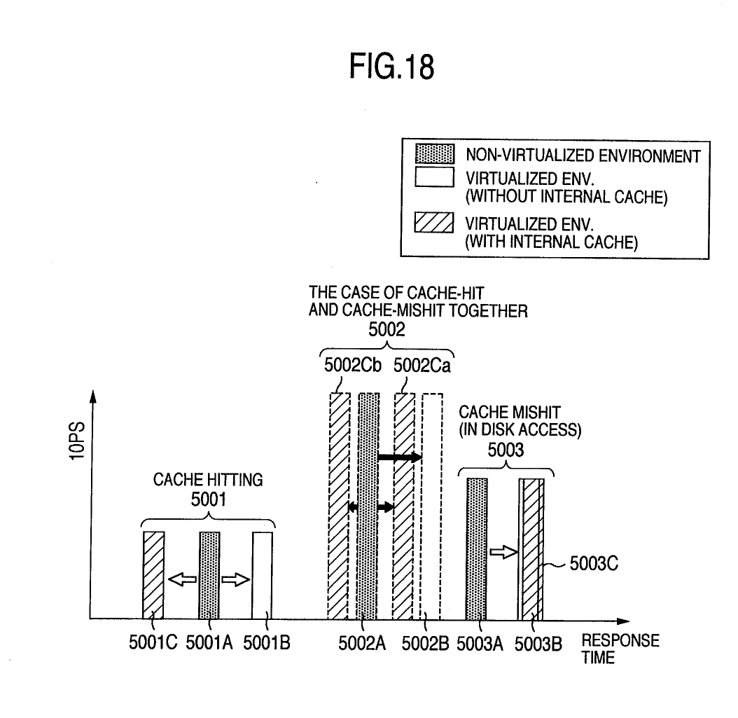

FIG. 18 is an explanation diagram showing a response time evaluation method. Shown herein are a response time 5001 upon cache hitting (referred to as “cache hit response time” hereinafter) due to the presence or absence of internal cache assignment in a non-virtualized environment and virtualized environment in this embodiment and a response time upon cache mishit (referred to hereinafter as “cache mishit response time) 5003 and also a volume response time 5002 which is obtained as follows:

a volume response time 5002 =(cache hit response time 5001)*(IOPS at cache hit)/(IOPS at cache hit+IOPS at cache mishit)+(cache mishit response time 5003)*(IOPS at cache mishit)/(IOPS at cache hit+IOPS at cache mishit),

where “IOPS” is input output per second.

Suppose that in the non-virtualized environment, the cache hit response time, cache mishit response time and volume response time are as indicated by 5001A, 5003A and 5002A, respectively, as shown in FIG. 18. In a transition of from the non-virtualized environment to virtualized environment (i.e., upon introduction of the virtualization apparatus 105), when considering a case where no internal cache is assigned, in the event of access from application server 101, access is given to storage device 106 via the virtualization apparatus 105 and SAN 104 without regard to whether the cache hit is present or absent.

Due to this access, a cache hit response time 5001B, cache mishit response time 5003B and volume response time 5002B are each delayed by the sum of a time taken to pass through the virtualization apparatus 105 and a time to pass through SAN 104, when compared to the cache hit response time 5001A, cache mishit response time 5003A and volume response time 5002A in the non-virtual environment, respectively.

On the other hand, consider a case where the internal cache assignment is performed in a transition of from the non-virtual environment to virtual environment. Assume here that an internal cache capacity to be assigned is the same as an external cache capacity which is presently assigned in the non-virtual environment and that the cache hit rate is kept unchanged. Also suppose that in cases where the internal cache and external cache are the same in capacity as each other, the data that exists on the external cache is also present on the internal cache so that there are no effects owing to the use of such external cache—therefore, this state is deemed to become substantially the same as a state with the external cache being removed away.

When comparing together the caches of storage device and the virtualization apparatus, the cache within virtualization apparatus 105 is higher in performance than the external cache 124 of storage device 106 in many cases. Consequently, when supposing that internal cache assignment is done in the transition of from the non-virtual to virtual environment, a cache hit response time 5001C in the case of an internal cache being assigned in the virtual environment becomes faster than the cache hit response time 5001A in the non-virtual environment.

A cache mishit response time 5003C in the case of the internal cache being assigned in the virtualized environment is the same as the cache mishit response time 5003B in the case of no internal cache being assigned in the virtual environment. Regarding the volume response time, it becomes faster (5002Ca) when compared to the case (5002B) of no internal cache being assigned in the virtual environment. In some cases, it becomes faster (5002Cb) than the volume response time 5002A in the non-virtual environment—this occurs depending on the quantity of input output per second (IOPS) at the time of cache hitting (5001C).

When considering it from a viewpoint of an application program 102 as another perspective, it is also thinkable that the response time of data existing on a cache to be accessed at frequent intervals is important. Thus, conceivable evaluation methodology includes a method for evaluation by using only the cache hit response time 5001 as the object to be evaluated, in addition to an evaluation method based on the volume response time 5002. Although an explanation below is directed to the evaluation method using the volume response time 5002, it is also possible to use an evaluation method using the cache hit response time 5001 only. In such case, the target response time is interpreted to be a target response time in a cache hit event.

### (Built-in Cache Capacity Estimation Processing)

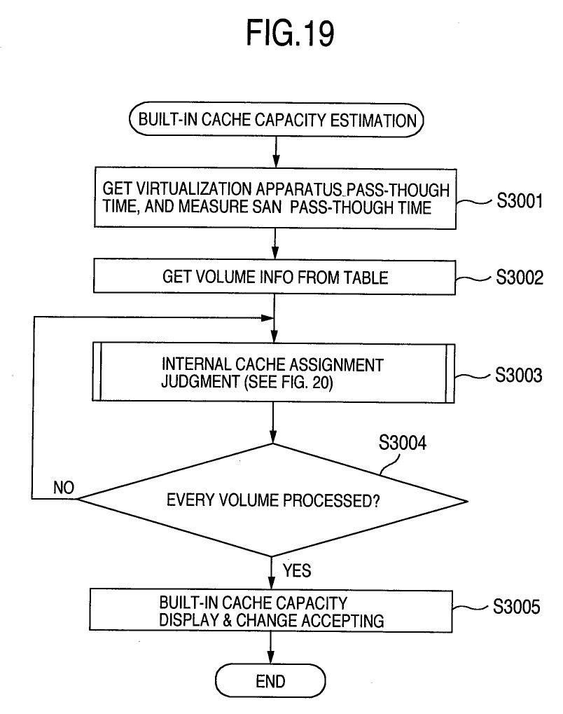

FIG. 19 is a flowchart showing built-in cache capacity estimation processing. The built-in cache capacity estimation program 1101 in the second embodiment is a process which is performed by the operations management program 201. The processing shown in FIG. 19 is executed by the CPU 108 (see FIG. 1), which reads the built-in cache capacity estimation program 1101 into the memory 109 and then executes it. Although the processing hardware is the CPU 108, its name will be omitted in the explanation below.

The processing starts with step S3001, which acquires the length of a time T_vrt as taken to pass through the virtualization apparatus 105 (referred to as “virtualization apparatus pass-though time” hereinafter) and a time T_net taken to pass through the SAN 104 (referred to hereafter as “SAN pass-though time”) which exists in a route of from virtualization apparatus 105 to storage device 106 in an event that application server 101 provides access to storage device 106 through virtualization apparatus 105. Note that in a strict sense, the virtualization apparatus pass-through time T_vrt is needed to be dealt differently in a case-sensitive way with a present situation being considered appropriately.

More specifically, in a case where an internal cache 123 has already been assigned when the application server 101 reads data, typical examples of the virtualization apparatus pass-through time are a time taken for a process having the steps of letting a request from application server 101 enter to virtualization apparatus 105, conducting a search for the internal cache and, upon failure to get any cache hit, letting the request exit virtualization apparatus 105 to approach storage device 106, and a time taken for a process having the steps of letting the data as read out of storage device 106 enter virtualization apparatus 105, writing the data into a presently assigned internal cache 123, letting it output from virtualization apparatus 105, and return to the server. Furthermore, in cases where the internal cache 123 is not assigned yet, examples of the virtualization apparatus pass-through time are a time taken to leave virtualization apparatus 105 for storage device 106 without execution of on-cache data search, and a time taken to return to application server 101 without execution of writing data into internal cache 123.

In this embodiment, its objective is to perform approximate calculation for the cache capacity estimation; so, any detailed case-by-case consideration is not carried out, and computation is performed under an assumption that the virtualization apparatus pass-through time has a single value in any events. Regarding the acquisition of the virtualization apparatus pass-through time T_vrt, this embodiment is arranged so that the built-in cache capacity estimation program 1101 prestores therein several specification values that are indicated on a product model catalog(s), although it may be modified so that the user makes changes at any time after installation of the operations management program 201. As for measurement of the SAN pass-though time T_net, a time taken to pass through SAN 103 in the non-virtualized environment is used in substitution therefor. One example of the measurement method has the steps of transmitting a signal which immediately returns a response to the controller 122 of storage device 106 from SAN interface 114, measuring the length of a time consumed to wait for return of a reply, and letting the half of such measured time be the SAN pass-though time T_net. In case two or more storage devices 106 are present, it is also permissible to perform measurement with respect to some of them and then use an average value thereof. Additionally, for the SAN pass-through time T_net also, it is possible to accept a value as input by the user.

At step S3002, necessary information is acquired from the cache configuration table 1005, access performance table 1006 and policy definition table 1007. Examples of the information to be obtained here are as follows: a storage device ID 1005A ID_str, volume ID 1005B ID_vol, external cache capacity 1005D C_ext and application program ID 1005F ID_ap, which are fetched from the cache configuration table 1005; an external cache hit rate 1006E R_ext, external cache response time 1006F T_ext, external disk response time 1006G T_dsk, average I/O size 1006H μ_{IO} and access frequency variance 10061 δ²_{freq}, which are gained from the access performance table 1006; a target response time 1007B T_tgt and permissible performance decrease degree 1007D D_prmt which are from the policy definition table 1007. Additionally, for an internal cache response time T_int, a specification value of catalog of the virtualization apparatus 105 is used.

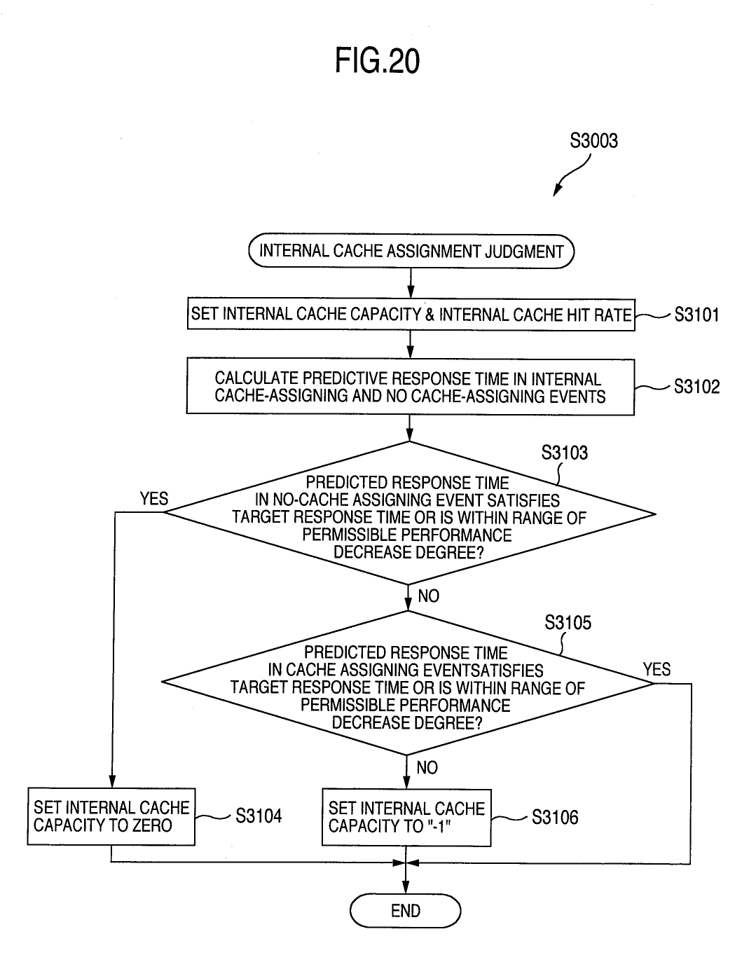

At step S3003, upon introduction of the virtualization apparatus 105, internal cache assignment judgment processing (see FIG. 20) is performed with respect to a virtual volume corresponding to the logical volume 126. For each volume in the internal cache configuration change plan storage table 1009 corresponding to the virtual volume to which the internal cache 123 is assigned, a cache capacity to be assigned is stored in the internal cache capacity 1009C. Details will be described later with reference to FIG. 20.

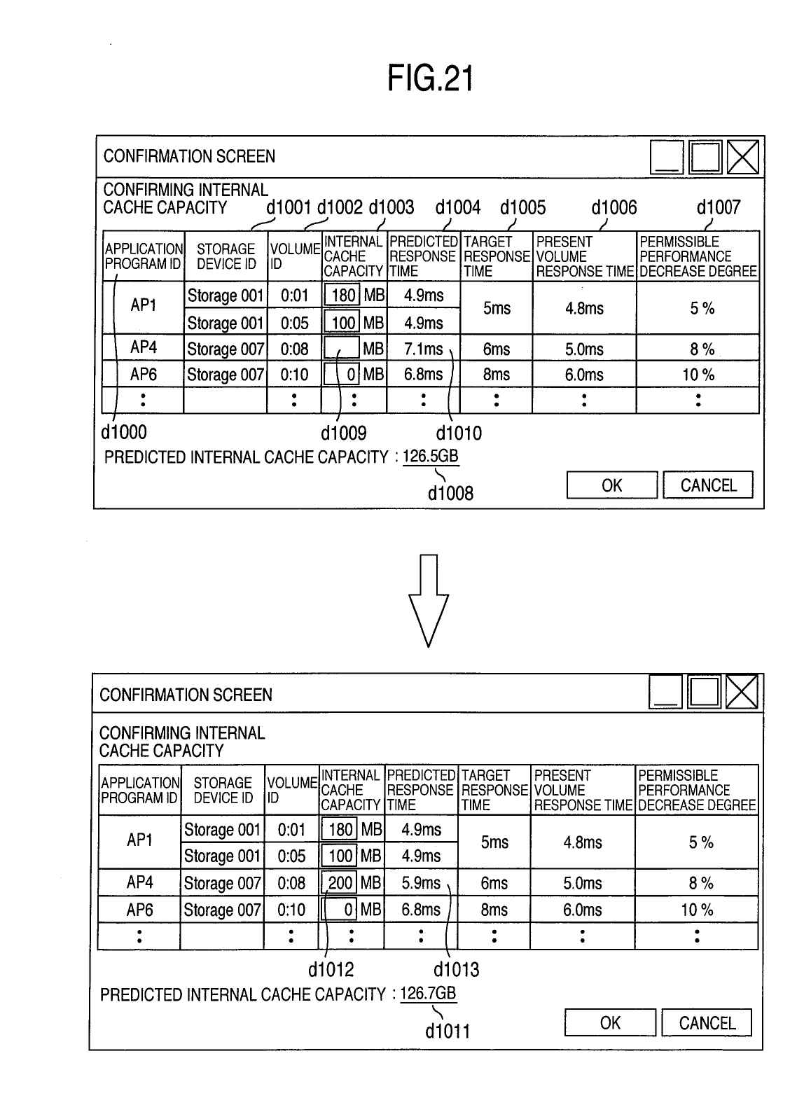

In step S3004, a decision is made as to whether the processing has been performed for every volume involved. In case the processing is not yet performed for every volume (i.e., if No at step S3004), return to the step S3003. Then, the process will be repeated until the processing is performed for all the logical volumes 126 that are being utilized from all application programs 102. In case the processing for every logical volume is completed (if Yes at step S3004), go to step S3005, which obtains through computation a total value of the amounts of internal cache capacity 1009C and then presents it to the user. Details of such presentation method will be described later with reference to FIG. 21.

### (Internal Cache Assignment Judgment Processing)

FIG. 20 is a flowchart showing details of the internal cache assignment judgment processing in the non-virtualized environment. In the internal cache assignment judgment processing at step S3003 shown in FIG. 20, judgment as to whether the internal cache assignment is needed or not is made by determining whether a predicted response time satisfies the target response time and/or whether resultant performance deterioration falls within the range of a permissible performance decrease degree D_prmt corresponding to the volume response time under the non-virtual or “real” environment.

At step S3101, an internal cache capacity C_int and internal cache hit rate R_int are determined (set up) based on the external cache capacity C_ext and external cache hit rate R_ext, respectively. The internal cache capacity C_int to be assigned is made equal to the external cache capacity C_ext. Assuming that the internal cache hit rate R_int at this time is the same as the external cache hit rate R_ext, the external cache hit rate R_ext is used as the internal cache hit rate R_int.

At step S3102, a predictive response time T_vol_wc at the time of internal cache assignment and a predictive response time T_vol_cl at the time of no cache assignment are obtained (calculated). These response time values are mathematically determinable by taking into consideration the virtualization apparatus pass-through time T_vrt and SAN pass-through time T_net, using Equations (A5) and (A6) below:

T_vol_{—}wc=R_int*T_int+(1−R_int)*{T_dsk+(T_vrt+T_net)*2} (A5)

T_vol_{—}cl=R_ext*{T_ext+(T_vrt+T_net)*2}+(1−R_ext)*{T_dsk+(T_vrt+T_net)*2} (A6)

It is noted here that the virtualization apparatus pass-through time T_vrt and SAN pass-through time T_net are each multiplied by 2 because a signal must pass through the virtualization apparatus 105 and SAN 104 twice in outbound and inbound routes when access is given from the application server 106.

At step S3103, a decision is made as to whether the predictive response time T_vol_cl in the case of the internal cache 123 being not assigned satisfies the target response time T_tgt or, alternatively, whether resultant performance decrement is within the range of the permissible performance decrease degree D_prmt relative to the volume response time in the non-virtual environment. In case it satisfies or is in range (i.e., if Yes at step S3103), it is assumed that the target performance is satisfiable without having to perform such internal cache assignment; then, go to step S3104.

At step S3104, the to-be-assigned internal cache capacity is set to “OMB,” and the internal cache hit rate is set at “0%”; then, store in the internal cache configuration change plan storage table 1009 the storage device ID ID_str, volume ID ID_vol, internal cache hit rate R_int, internal cache response time T_int, external cache hit rate R_ext, external cache response time T_ext, external disk response time T_dsk, average I/O size μ_{IO} and access frequency variance δ²_{freq}, followed by termination of the processing.

At step S3103, in case the predictive response time T_vol_cl in the internal cache assignment event fails to satisfy the target response time T_tgt or, alternatively, the resulting performance decrement is out of the range of permissible performance decrease degree D_prmt (i.e., if No at step S3103), the procedure goes to step S3105.

At step S3105, the predictive response time T_vol_wc upon assignment of the internal cache is compared to the target response time T_tgt to thereby determine whether the internal cache assignment results in the predictive response time satisfying the target response time T_tgt or, alternatively, whether the resultant performance degradation is within the range of the permissible performance decrease degree D_prmt with respect to the volume response time in the non-virtual environment. In case the internal cache assignment results in the predictive response time satisfying the target response time T_tgt or in case it is within the range of the permissible performance decrease degree D_prmt with respect to the volume response time in the non-virtual environment (i.e., if Yes at step S3105), the internal cache is decided to be assigned; then, data values of the storage device ID ID_str, volume ID ID_vol, internal cache hit rate R_int, external cache hit rate R_ext, external cache response time T_ext, external disk response time T_dsk are stored in the internal cache configuration change plan storage table 1009 (see FIG. 8A) along with other information items, followed by quitting of the processing.

In step S3105, in case the predictive response time T_vol_wc at the time of internal cache assignment does not satisfy the target response time T_tgt or when the resulting performance decrease is out of the range of the permissible performance decrease degree D_prmt (if No at step S3105), go to step S3106.

At step S3106, in view of the fact that execution of the internal cache assignment results in the predictive response time fails to satisfy the target response time or in the resultant performance being out of the range of permissible performance decrease degree D_prmt, the internal cache assignment is prevented. As far as this is concerned, this step is the same as the step S3104 but is different from step S3104 in that the internal cache capacity is set to a negative value (e.g., −1 MB). This indicates that it is impossible to satisfy the expected performance even when assigning the internal cache as has been stated supra in conjunction with FIG. 8A. Lastly, in a similar way to step S3104, the internal cache hit rate is set to “0%” and then stored in the internal cache configuration change plan storage table 1009 together with other information, followed by end of the processing.

### (Estimated Internal Cache Capacity Confirmation/Modify Screen)

FIG. 21 is an exemplary display screen showing a result of the built-in cache capacity estimation processing. The built-in cache capacity estimation processing result is visually indicated to the user by means of the display unit 110. In this on-screen display example, a predictive response time d1004, target response time d1005, present volume response time d1006 and permissible performance decrease degree d1007 are displayed together with respect to an internal cache capacity d1003 which was estimated per volume having a storage device ID d1001 to be accessed (used) by application program ID (d1000) and a volume ID d1002. At lower part of this screen is displayed a total value d1008 of estimated amounts of internal cache capacity with necessity for mounting.

In an on-screen display example shown at upper part of FIG. 21, the application program ID (d1000) is such that its internal cache capacity d1003 of application No. 4 (AP4) is a blank column d1009. This indicates that the predictive response time does not satisfy the target response time and, at the same time, fails to fall within the range of permissible performance decrease degree D_prmt relative to the volume response time in the non-virtualized environment without regard to whether an internal cache that is the same in capacity as the external cache in the non-virtual environment is actually assigned or not.

The internal cache capacity d1003 is value-changeable by the user when the need arises. For example, the blank space d1009 may be changed to indicate “200 MB” (d1012). If this is the case, the estimated value of internal cache capacity also is updated; for example, its present value “126.5 GB” (d1008) is changed to “126.7 GB” (d1011). In addition, based on this changed internal cache capacity, a new value of the predictive response time d1004 is recalculated—e.g., its “7.1 ms” (d1010) is updated to “5.9 ms” (d1013). The recalculation of the predictive response time at this time is performed in a way which follows. First, an internal cache hit rate R_int after the value change is obtained using the average I/O size μ_{IO}, access frequency variance δ²_{freq} and cache hit rate table 1008 (for detail, see the flowchart of FIG. 10). Then, this modified internal cache hit rate R_int is used to obtain the intended predictive response time by the T_vol_wc calculation method, which has been stated in the explanation of the step S3102.

According to this embodiment, in the storage system having at least one application server 101, two or more storage devices 106, virtualization apparatus 105 which enables recognition of any one of these storage devices 106 as a routinely virtualized storage, and storage management server 107, the storage management server 107 predicts a response time with respect to the application server 101 of virtualization apparatus 105 from cache configurations and access performances of the virtualization apparatus 105 and storage device(s) 106 and then evaluates the presence or absence of assignment of internal cache 123 to virtual volume 125 and assignment amount-dependent predictive performance value to thereby perform decision or “judgment” of the cache capacity within virtualization apparatus 105 and estimation of an appropriate cache capacity, thus making it possible to prepare an internal cache configuration change plan.

According to this embodiment, efficient utilization of storage device resources is performed by a method which follows.
(1) Prior to introduction of the virtualization apparatus, a response time of external storage device is measured. Then, a predictive value of the response time after transition to the virtualized environment is calculated. Next, a feature value or values are calculated in both of the case of assigning the cache within virtualization apparatus and the case of assigning no such cache; then, compare them to each other. Based on a target response time and/or a decrement degree from prior-to-introduction performance value, a decision is made as to whether the virtualization apparatus's cache assignment is necessary or not, followed by calculation of the amount of a cache capacity needed for the virtualization apparatus in the virtualization apparatus introduction event.
(2) In cache configuration management in the virtualization apparatus-introduced environment, in case a response time calculated satisfies the target response time, the cache capacity within virtualization apparatus is reduced in amount, and a cache capacity which satisfies the target response time is calculated in combination with the cache(s) of an external storage device(s), followed by preparation of a cache configuration plan.
(3) In accordance with the cache configuration plan thus prepared, a presently established cache configuration is modified or updated. In addition, the I/O characteristics are monitored at regular time intervals for dynamically performing preparation and execution of a cache configuration change plan to thereby optimize the cache configuration.

According to this embodiment, (1) it is possible for a storage device(s) being externally linked to the virtualization apparatus to readily perform the decision as to whether the internal cache within such virtualization apparatus is assigned or not. It is also possible to make easier the calculation of such internal cache capacity to be assigned. (2) Furthermore, the virtualization apparatus's cache resource is maximally utilizable at every part of the storage system. Prior to the introduction of virtualization apparatus, it is possible to estimate the optimum amount of internal cache capacity as built in the virtualization apparatus.

It should be further understood by those skilled in the art that although the foregoing description has been made on embodiments of the invention, the invention is not limited thereto and various changes and modifications may be made without departing from the spirit of the invention and the scope of the appended claims.

1. A cache configuration management system for use in a storage system including a plurality of application servers, a plurality of storage devices having a plurality of logical volumes, and a virtualization apparatus for allowing said plurality of storage devices to be distinguishably recognized as storages being virtualized predeterminedly, wherein said application servers and said storage devices and said virtualization apparatus are communicably linked together via a first network while simultaneously letting said application servers and said storage devices and said virtualization apparatus be communicable with a management server via a second network, said cache configuration management system being for managing a cache configuration within said virtualization apparatus, said management server comprising:
cache configuration information collecting means adapted to gather information as to a configuration of an internal cache which indicates a cache capacity being assigned to each virtual volume of said virtualization apparatus in units of application programs within said application servers and information of a configuration of an external cache which indicates a cache capacity being assigned to a logical volume of each said storage device, and store the collected information in a storage unit as cache configuration information;
access performance information collecting means adapted to collect access performance data including a cache hit rate and a response time with respect to each of said virtualization apparatus and said storage devices in an event of giving access to said logical volume from any one of said application programs and store a collection result in said storage device as access performance information;
policy definition information setup means, responsive to receipt of a target performance value of the application program from an input unit, adapted to store the target performance value in said storage unit as policy definition information;
internal cache configuration change plan preparation means adapted to calculate a predictive performance value after change of the cache capacity of said internal cache in said virtualization apparatus based on the target performance value of said application program on its corresponding application server and the internal cache configuration of said virtualization apparatus and also the external cache configuration of said storage device, estimate a to-be-assigned capacity of a cache memory of said internal cache in such a manner that said predictive performance value satisfies said target performance value, and prepare an internal cache configuration change plan of said virtualization apparatus; and
internal cache configuration execution means, responsive to receipt of an internal cache configuration change instruction from said input unit, adapted to issue a request for changing the internal cache configuration toward said virtualization apparatus based on said internal cache configuration change plan thus prepared and change said internal cache configuration.

2. The cache configuration management system according to claim 1, wherein said target performance value is a target response time, wherein said access performance information collecting means prestores therein an internal cache response time which is a response time upon occurrence of cache hitting to the internal cache in said virtualization apparatus when providing access to the logical volume within said storage device from said application program, an external cache response time which is a response time upon occurrence of cache hitting to said external cache, and an external disk response time which is a response time when giving access to said logical volume, and wherein said internal cache configuration change plan preparation means calculates a predictive response time when access is given to said logical volume of said storage device from said application program based on said internal cache response time, said external cache response time, said external disk response time, an internal cache hit rate which is a cache hit rate corresponding to the cache capacity of said internal cache, and an external cache hit rate which is a cache hit rate of the external cache under an assumption that said internal cache capacity is zero.

3. The cache configuration management system according to claim 1, wherein said policy definition information setup means is responsive to receipt of an importance degree of said application program from said input unit for storing the importance degree in said policy definition information, and wherein said internal cache configuration change plan preparation means performs assignment of said cache memory capacity while putting higher priority to said application program with said importance degree being high in a case where a total value of estimated cache memory capacities is larger than the capacity of the cache as built in said virtualization apparatus.

4. The cache configuration management system according to claim 1, wherein said policy definition information setup means is responsive to receipt of an importance degree of said application program from said input unit for storing the importance degree in said policy definition information, and wherein said internal cache configuration change plan preparation means performs assignment of said cache memory satisfying the target performance value of said application program and assigns said application program being high in said importance degree while putting higher priority thereto when causing the to-be-assigned cache memory capacity to increase in cases where said virtualization apparatus is surplus in capacity of the cache memory as built therein.

5. The cache configuration management system according to claim 1, wherein said management server further comprises:
internal cache configuration change schedule preparing means adapted to predict, based on a change in input/output characteristics of access from said application program, how the internal cache configuration is changed at what time point in order for said application program to satisfy the target performance value, and prepare an internal cache configuration change schedule.

6. A management server for use with a plurality of application servers, a plurality of storage devices having a plurality of logical volumes, and a virtualization apparatus for allowing said plurality of storage devices to be distinguishably recognized as predeterminedly virtualized storages, said application servers and said storage devices and said virtualization apparatus being communicably linked together via a first network, said management server being for managing via a second network said application servers and said storage devices and said virtualization apparatus, said management server comprising:
cache configuration information collecting means adapted to gather information as to a configuration of an internal cache which indicates a cache capacity being assigned to each virtual volume of said virtualization apparatus in units of application programs within said application servers and information of a configuration of an external cache which indicates a cache capacity being assigned to a logical volume of each said storage device, and store the collected information in a storage unit as cache configuration information;
access performance information collecting means adapted to collect access performance data including a cache hit rate and a response time with respect to each of said virtualization apparatus and said storage devices in an event of giving access to said logical volume from any one of said application programs and store a collection result in said storage device as access performance information;
policy definition information setup means, responsive to receipt of a target performance value of the application program from an input unit, adapted to store the target performance value in said storage unit as policy definition information;
internal cache configuration change plan preparation means adapted to calculate a predictive performance value after change of the cache capacity of said internal cache in said virtualization apparatus based on the target performance value of said application program on its corresponding application server and the internal cache configuration of said virtualization apparatus and also the external cache configuration of said storage device, estimate a to-be-assigned capacity of a cache memory of said internal cache in such a manner that said predictive performance value satisfies said target performance value, and prepare an internal cache configuration change plan of said virtualization apparatus; and
internal cache configuration execution means, responsive to receipt of an internal cache configuration change instruction from said input unit, adapted to issue a request for changing the internal cache configuration toward said virtualization apparatus based on said internal cache configuration change plan thus prepared and change said internal cache configuration.

7. The management server according to claim 6, wherein said target performance value is a target response time, wherein said access performance information collecting means prestores therein an internal cache response time which is a response time upon occurrence of cache hitting to the internal cache in said virtualization apparatus when providing access to the logical volume within said storage device from said application program, an external cache response time which is a response time upon occurrence of cache hitting to said external cache, and an external disk response time which is a response time when giving access to said logical volume, and wherein said internal cache configuration change plan preparation means calculates a predictive response time when access is given to said logical volume of said storage device from said application program based on said internal cache response time, said external cache response time, said external disk response time, an internal cache hit rate which is a cache hit rate corresponding to the cache capacity of said internal cache, and an external cache hit rate which is a cache hit rate of the external cache under an assumption that said internal cache capacity is zero.

8. The management server according to claim 6, wherein said policy definition information setup means is responsive to receipt of an importance degree of said application program from said input unit for storing the importance degree in said policy definition information, and wherein said internal cache configuration change plan preparation means performs assignment of said cache memory capacity while putting higher priority to said application program with said importance degree being high in a case where a total value of estimated cache memory capacities is larger than the capacity of the cache as built in said virtualization apparatus.

9. The management server according to claim 6, wherein said policy definition information setup means is responsive to receipt of an importance degree of said application program from said input unit for storing the importance degree in said policy definition information, and wherein said internal cache configuration change plan preparation means performs assignment of said cache memory satisfying the target performance value of said application program and assigns said application program being high in said importance degree while putting higher priority thereto when causing the to-be-assigned cache memory capacity to increase in cases where said virtualization apparatus is surplus in capacity of the cache memory as built therein.

10. The management server according to claim 6, further comprising:
internal cache configuration change schedule preparing means adapted to predict, based on a change in input/output characteristics of access from said application program, how the internal cache configuration is changed at what time point in order for said application program to satisfy the target performance value, and prepare an internal cache configuration change schedule.

11. A cache configuration management method for use in a storage system including a plurality of application servers, a plurality of storage devices having a plurality of logical volumes, and a virtualization apparatus for allowing said plurality of storage devices to be distinguishably recognized as predetermined virtual storages, wherein said application servers and said storage devices and said virtualization apparatus are communicably linked together via a first network while simultaneously letting said application servers and said storage devices and said virtualization apparatus be communicable with a management server via a second network, said cache configuration management method being for managing a cache configuration within said virtualization apparatus, said method causing said management server to perform a process comprising:
a cache configuration information collecting step of gathering information as to a configuration of an internal cache which indicates a cache capacity being assigned to each virtual volume of said virtualization apparatus in units of application programs within said application servers and information of a configuration of an external cache which indicates a cache capacity being assigned to a logical volume of each said storage device, and then storing the collected information in a storage unit as cache configuration information;
an access performance information collecting step of collecting access performance data including a cache hit rate and a response time with respect to each of said virtualization apparatus and said storage devices in an event of giving access to said logical volume from any one of said application programs and then storing a collection result in said storage device as access performance information;
a policy definition information setup step of, upon receipt of a target performance value of the application program from an input unit, storing the target performance value in said storage unit as policy definition information;
an internal cache configuration change plan preparation step of calculating a predictive performance value after change of the cache capacity of said internal cache in said virtualization apparatus based on the target performance value of said application program on its corresponding application server and the internal cache configuration of said virtualization apparatus and also the external cache configuration of said storage device, estimating a to-be-assigned capacity of a cache memory of said internal cache in such a manner that said predictive performance value satisfies said target performance value, and preparing an internal cache configuration change plan of said virtualization apparatus; and
an internal cache configuration execution step of issuing, upon receipt of an internal cache configuration change instruction from said input unit, a request for changing the internal cache configuration toward said virtualization apparatus based on said internal cache configuration change plan thus prepared and then changing said internal cache configuration.

12. The cache configuration management method according to claim 11, wherein said target performance value is a target response time, wherein said access performance information collecting step includes prestoring therein an internal cache response time which is a response time upon occurrence of cache hitting to the internal cache in said virtualization apparatus when providing access to the logical volume within said storage device from said application program, an external cache response time which is a response time upon occurrence of cache hitting to said external cache, and an external disk response time which is a response time when giving access to said logical volume, and wherein said internal cache configuration change plan preparation step includes calculating a predictive response time when access is given to said logical volume of said storage device from said application program based on said internal cache response time, said external cache response time, said external disk response time, an internal cache hit rate which is a cache hit rate corresponding to the cache capacity of said internal cache, and an external cache hit rate which is a cache hit rate of the external cache under an assumption that said internal cache capacity is zero.

13. The cache configuration management method according to claim 11, wherein said policy definition information setup step is responsive to receipt of an importance degree of said application program from said input unit for storing the importance degree in said policy definition information, and wherein said internal cache configuration change plan preparation step performs assignment of said cache memory capacity while putting higher priority to said application program with said importance degree being high in a case where a total value of estimated cache memory capacities is larger than the capacity of the cache as built in said virtualization apparatus.

14. The cache configuration management method according to claim 11, wherein said policy definition information setup step is responsive to receipt of an importance degree of said application program from said input unit for storing the importance degree in said policy definition information, and wherein said internal cache configuration change plan preparation step performs assignment of said cache memory satisfying the target performance value of said application program and assigns said application program being high in said importance degree while putting higher priority thereto when causing the to-be-assigned cache memory capacity to increase in cases where said virtualization apparatus is surplus in capacity of the cache memory as built therein.

15. The cache configuration management method according to claim 11, wherein the process of said management server further comprises:
an internal cache configuration change schedule preparing step of predicting, based on a change in input/output characteristics of access from said application program, how the internal cache configuration is changed at what time point in order for said application program to satisfy the target performance value, and then preparing an internal cache configuration change schedule.
